(19) United States
(12) Patent Application Publication
(10) Pub. No.: US 2023/0399520 A1
(43) Pub. Date: Dec. 14, 2023

(54) A METHOD OF MAKING A THREE-DIMENSIONAL PRINTED CARBON-BONDED COMPOSITE ARTICLE

(71) Applicants: Arkema France, Colombes (FR); CONTINUOUS COMPOSITES, INC., Coeur d'Alene, ID (US)

(72) Inventors: Tyler B. Alvarado, Coeur d’Alene, ID (US); Brock Adam Jahner, Coeur d’Alene, ID (US); Sean Nunez, Barcelona (ES); Andrew John Overby, Coeur d’Alene, ID (US); Jeremiah R. Smith, Coeur d’Alene, ID (US); Kyle Snow, Exton, PA (US); Ryan C. Stockett, Spokane, WA (US); Nathan Andrew Stranberg, Post Falls, ID (US); William Wolf, Exton, PA (US)

(73) Assignee: Arkema France, Colombes (FR)

(21) Appl. No.: 18/032,880

(22) PCT Filed: Oct. 20, 2021
(86) PCT No.: PCT/US2021/055779

§ 371 Date: Apr. 20, 2023

Related U.S. Application Data
(60) Provisional application No. 63/094,805, filed on Oct. 21, 2020.

(51) Int. Cl. C09D 4/00; B33Y 10/00; B33Y 40/20; B33Y 50/00; C09D 133/06; C09D 135/02; C09D 7/61; C09D 7/40; C09D 7/63; C01B 32/05

(52) U.S. Cl. CPC C09D 4/00; B33Y 10/00; B33Y 40/20; B33Y 50/00; C09D 133/062; C09D 135/02; C09D 7/61; C09D 7/70; C09D 7/63; C01B 32/05; B29C 64/118

(57) ABSTRACT

A method is disclosed for us in additively manufacturing a three-dimensional carbon-bonded composite article. The method may include discharging from a print head a curable composition. The curable composition may include a) at least one aromatic, actinically curable component having an H/Catomic ratio of from 0.4 to 1.6, selected from the group consisting of (meth)acrylate oligomers, epoxy-functionalized compounds, oxetane-functionalized compounds and mixtures thereof; and b) at least one diluent comprising at least one actinically curable monomer. The curable composition may also include c) a reinforcement, and d) a photoinitiator. The method may further include irradiating the curable composition during the discharging to at least partially actinically cure the curable composition and form a preform of the three-dimensional carbon-bonded composite article. The method also includes pyrolyzing the preform to form the three-dimensional printed carbon-bonded composite article.

### RELATED APPLICATION

This application is based on and claims the benefit of priority from U.S. Provisional Application No. 63/094,805 that was filed on Oct. 21, 2020, the contents of which are expressly incorporated herein by reference.

### TECHNICAL FIELD

The present disclosure relates generally to a system and method for additively manufacturing a composite structure from a composition.

### BACKGROUND

A composite is a material made from multiple different constituents that, when put together, have a property enhanced above the same property of the individual constituents. For example, a composite material may be lighter, stronger, stiffer, harder, tougher, more heat resistant, etc. than the constituent materials used to make the composite material. One example application of a composite is in high-temperature environments, where weight, strength and durability are important considerations. This can include aerospace applications, such as components of a flight or space vehicle engine, heat shields, and rocket nozzles; nuclear applications, such as fuel rod insulators; and other applications.

Multiple types of composites may be used in high-temperature environments. These types include, among others, carbon bonded fiber composites (CBFCs), such as carbon-bonded-carbon and carbon-bonded-ceramic composites; and ceramic matrix composites (CMCs), such as ceramic-bonded-carbon and ceramic-bonded-ceramic composites. While these types of composites may provide many benefits, their fabrication can be difficult, time consuming and expensive. Accordingly, their uses are currently limited.

For example, a typical fabrication process for making a CBFC or a CMC component includes first coating fibers (e.g., carbon or ceramic fibers) with a material that promotes anisotropic performance of the fibers. Coated fibers are then laid by hand into a mold or wrapped around a mandrel, both having a nondescript shape and a size that is significantly greater than an intended final size of the desired component. The fibers are thereafter saturated with a resin, and the mold, fibers and resin are placed into an oven and heated to a temperature at which the resin pyrolyzes into carbon or a ceramic. The pyrolyzing creates voids within the resulting structure that must then be filled with more resin. The mold is again placed into the oven and heated, and the process is repeated until a porosity of the resulting structure is sufficiently low for the intended application. At this point in time, a generically shaped block of composite material is produced, which must then be subtractively machined to a desired net shape. Because of a hardness of the composite material (particularly CMCs), the machining can be difficult.

While CBFCs and CMCs may perform well in certain applications, the processes to fabricate them are labor, time and material exhaustive. This makes these composite components expensive and limits their applications. The disclosed additive manufacturing system and method are uniquely configured to address these and other issues of the prior art.

### SUMMARY

In one aspect, the present disclosure is directed to a method of making a three-dimensional printed carbon-bonded composite article using an additive manufacturing system.

The method may include discharging from a print head a curable composition. The curable composition may include a) at least one aromatic, actinically curable component having an H/C_{atomic ratio} of from 0.4 to 1.6, selected from the group consisting of (meth)acrylate oligomers, epoxy-functionalized compounds, oxetane-functionalized compounds and mixtures thereof, and b) at least one diluent comprising at least one actinically curable monomer. The curable composition may also include c) a reinforcement, and d) a photoinitiator. The method may further include irradiating the curable composition during the discharging to at least partially actinically cure the curable composition and form a preform of the three-dimensional carbon-bonded composite article.

In one aspect, the method further includes pyrolyzing the preform to form the three-dimensional printed carbon-bonded composite article.

In one aspect, the curable composition has a viscosity of at most 60,000 mPa·s at 25° C. prior to irradiating the curable composition.

In one aspect, the a) comprises at least one aromatic, actinically curable component having an H/C_{atomic ratio} of from 0.7 to 1.4.

In one aspect, the b) comprises actinically curable monomer having an aromatic content of at least 1.

In one aspect, the curable composition creates at least 18 weight % char, in particular at least 20 weight % char, more particularly more than 22.5 weight % char, even more particularly more than 25 weight % char, after pyrolizing as measured by thermogravimetric analysis after 3 hour hold at 400° C., based on the weight of the a), the b) and the d) after actinically curing.

In one aspect, the a) comprises a (meth)acrylated epoxy novolak rein.

In one aspect, the combination of the a) and the b) has a net H/C_{atomic ratio} of from 0.4 to 1.6.

In one aspect, the a) comprises at least one aromatic, actinically curable component comprising at least one (meth)acrylate group per molecule.

In one aspect, the a) comprises at least one aromatic, actinically curable component comprising at least two (meth)acrylate groups per molecule.

In one aspect, the a) comprises at least one aromatic, actinically curable component comprising at least one epoxy group per molecule.

In one aspect, the a) comprises at least one aromatic, actinically curable component comprising at least one epoxy group per molecule and at least one (meth)acrylate group per molecule.

In one aspect, the a) comprises a first compound comprising at least one epoxy group per molecule, and a second compound comprising at least one (meth)acrylate group per molecule.

In one aspect, the b) comprises at least one actinically curable monomer comprising at least one (meth)acrylate group per molecule.

In one aspect, the b) comprises at least one actinically curable monomer comprising at least two (meth)acrylate groups per molecule.

In one aspect, the b) comprises at least one actinically curable monomer comprising at least one epoxy group per molecule.

In one aspect, the b) comprises at least one actinically curable monomer comprising at least one epoxy group per molecule and at least one (meth)acrylate group per molecule.

In one aspect, the b) comprises a first compound comprising at least one epoxy group per molecule, and a second compound comprising at least one (meth)acrylate group per molecule.

In one aspect, the c) comprises carbon fibers.

In one aspect, the c) comprises continuous fibers.

In one aspect, the c) comprises particles present in an amount of at least 0.5% by weight of the curable composition.

In one aspect, the c) comprises a fiber and is present in an amount of at least 0.5% by weight of the curable composition.

In one aspect, the reinforcement is opaque and the curable composition further comprises at least one UV transparent reinforcement.

In one aspect, the curable composition further includes at least one thermal initiator, in particular an azo compound or a peroxide, more particularly an azonitrile or an organic peroxide.

In one aspect, the a) is an (meth)acrylated epoxy novolak resin, the b) is selected from the group consisting of an ethoxylated bisphenol A diacrylate (in particular ethoxylated3 bisphenol A diacrylate), 2-phenoxyethyl acrylate, tert-butylcyclohexyl acrylate, tricyclodecane dimethanol diacrylate, tris(2-hydroxy ethyl)isocyanurate triacrylate, mono- or polyoxyethylene p-cumylphenyl ether acrylate, trimethylolpropane triacrylate, and mixtures thereof, the d) is a phosphine oxide, and the curable composition further comprises at least one thermal initiator.

In one aspect, the curable composition further includes at least one non-curable char-forming constituent, selected from the group consisting of tar pitches, petroleum products, non-functionalized novolaks, carbore, pitch, lignite, tar, creosote and mixtures thereof.

In one aspect, the curable composition further includes at least one non-curable char-forming constituent which is lignin.

In one aspect, irradiating the curable composition pyrolizes the curable composition in the preform.

In one aspect, the method further includes densifying the preform with at least one of a liquid and a gas.

In one aspect, the at least one of the liquid and the gas is the curable composition.

In one aspect, the method further includes heating the preform to pyrolyze the at least one of the liquid and the gas.

In one aspect, the method further includes repeating the densifying and the heating until at least a threshold porosity in the three-dimensional printed carbon-bonded composite article is achieved.

In one aspect, the densifying includes directing the at least one of the liquid and the gas into the preform from a supply located onboard the print head.

In one aspect, the heating includes directing heat into the preform from a heater located onboard the print head.

In one aspect, the irradiating includes directing cure energy into the preform from a cure enhancer located onboard the print head.

In one aspect, the discharging, the irradiating, the densifying, and the heating are completed simultaneously.

In one aspect, the discharging, the irradiating, the densifying, and the heating are completed at different locations.

In one aspect, the present disclosure is directed to another method of making a three-dimensional printed carbon bonded composite article. This method may include discharging from a print head a curable composition having a viscosity of at most 60,000 mPa·s at 25° C. The curable composition may include a) at least one aromatic, actinically curable component having an H/C_{atomic ratio} of from 0.4 to 1.6, selected from the group consisting of (meth)acrylate oligomers, epoxy-functionalized compounds, oxetane-functionalized compounds and mixtures thereof, b) at least one diluent comprising at least one actinically curable monomer, c) at least one of a carbon reinforcement and a ceramic reinforcement, and d) a photoinitiator. The method may further include directing cure energy from a cure enhancer mounted on the print head to the curable composition during the discharging to at least partially cure the curable composition and form a preform of the three-dimensional printed carbon-bonded composite article. The method may also include heating the preform with a heater mounted on the print head during the discharging to pyrolize the curable composition in the preform, wherein the curable composition creates more than 18 weight % char during the heating as measured by thermogravimetric analysis after 3 hour hold at 400° C., based on a weight of the a), the b) and the d) after actinically curing.

In one aspect, the method includes densifying the preform with at least one of a liquid and a gas after the heating, and heating the preform to pyrolyze the at least one of the liquid and the gas.

### BRIEF DESCRIPTION OF THE DRAWINGS

FIG. 1 is a diagrammatic illustration of an exemplary disclosed manufacturing system; and

FIG. 2 is a schematic illustration of a fabrication process that can be completed by the manufacturing system of FIG. 1.

### DETAILED DESCRIPTION

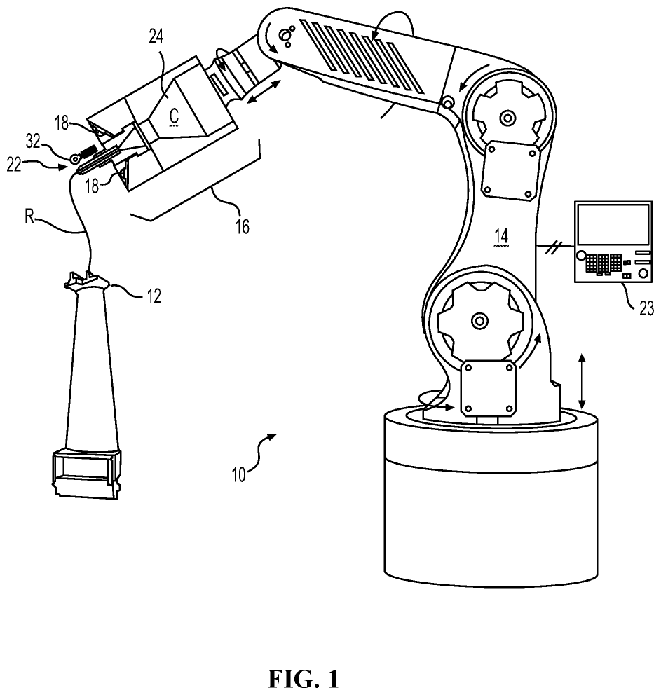

FIG. 1 illustrates an exemplary additive manufacturing system (“system”) 10, which may be used to manufacture a composite structure (e.g., a turbine blade, a rocket nozzle, a heat shield, a nuclear fuel rod insulator, etc.) 12 having a desired net or near-net shape (e.g., without substantial subtractive machining being required to achieve net shape). System 10 may include a support 14 and one or more deposition heads (“head”) 16. Head(s) 16 may be coupled to and moveable by support 14. In the disclosed embodiment of FIG. 1, support 14 is a robotic arm capable of moving head(s) 16 in multiple directions during fabrication of structure 12. Support 14 may alternatively embody a gantry (e.g., an overhead bridge or single-post gantry) or a hybrid gantry/arm also capable of moving head(s) 16 in multiple directions during fabrication of structure 12. Although support 14 is shown as being capable of movements along or about 6-axes, it is contemplated that support 14 may be capable of moving head(s) 16 in a different manner (e.g., along or about a greater or lesser number of axes). In some embodiments, a drive may mechanically couple head(s) 16 to support 14 and include components that cooperate to move portions of and/or supply power or materials to head 16.

Each head 16 may be configured to receive or otherwise contain a resin composition (“composition,” shown as C in the figures). The composition may include any type of liquid (e.g., a suspension or a solution) that is curable to a solid or semi-solid state (e.g., curable sufficient to hold a green shape of structure 12 during subsequent processing) and/or pyrolyzable into carbon or a ceramic via application of energy (e.g., light, radiation, heat, pressure, chemical catalyst, vibration, magnetic field, etc.). Exemplary compositions include thermosets (e.g., phenolics, furans, (meth)acrylates, epoxies, etc.), pitches, ceramic precursors (e.g., SiC, Si₃N₄, BN, AIN, SiOC, SiCN, BCN, etc.), and others.

In one embodiment, the composition inside head 16 may be pressurized, for example by an external device (e.g., by an extruder, a pump, etc.—not shown) that is fluidly connected to head 16 via a corresponding conduit (not shown). In another embodiment, however, the pressure may be generated completely inside of head 16 by a similar type of device. In yet other embodiments, the composition may be gravity-fed into and/or through head 16. For example, the composition may be fed into head 16, and pushed or pulled out of head 16 along with one or more reinforcements (shown as R in FIG. 1). In some instances, the composition inside head 16 may need to be kept cool and/or dark to inhibit premature curing or otherwise obtain a desired rate of curing after discharge. In other instances, the composition may need to be kept warm and/or illuminated for similar reasons. In either and other situations, head 16 may be specially configured (e.g., insulated, temperature-controlled, shielded, etc.) to provide for these needs.

In some applications, one or more additives may be mixed into the composition at a location upstream of and/or inside of head 16. These additives may be selected to enhance a property of structure 12. For example, the additives may include constituents (e.g., B, Zr, etc.) that increase a thermal operational range of structure 12, constituents (e.g., Fe, Co, Ni, etc.) that increase a magnetic property of structure 12, constituents (e.g., ferrous materials) that enhance the action of pyrolysis, and/or constituents (e.g., Cu, Pd, Pt, etc.) that increase a catalytic property of structure 12.

The composition (i.e., with or without any additives) may be used to coat any number of reinforcements that enhance a mechanical property of structure 12, including continuous reinforcements and discontinuous reinforcements. For the purposes of this disclosure, continuous reinforcements may be considered to have an aspect ratio (V) defined as a length (L) divided by a diameter (d) (e.g., V=L/d) that is greater than 10, 100, 1000, 100,000, 1,000,000 or even larger. Discontinuous reinforcements may include reinforcements having an aspect ratio less than that of continuous reinforcements.

The reinforcements may be supplied in the form of powder, particles, chopped fibers, unchopped fibers, tows, braids, rovings, fabrics, knits, mats, socks, sheets, tubes, etc. of material that, together with the composition, make up a composite portion (e.g., a wall) of structure 12. The reinforcements may be stored within or otherwise passed through head 16 (e.g., fed from one or more spools or hoppers—not shown). When multiple reinforcements are simultaneously used, the reinforcements may be of the same material and have the same sizing and cross-sectional dimension and shape, or a different material with different sizing and/or cross-sectional dimension and shape. The sizing may include, for example, treatment of the reinforcement with plasma or treatment with an acid (e.g., nitric acid), or otherwise be surface-functionalized with an agent (e.g., a dialdehyde, an epoxy, a vinyl, and/or another functional group) to enhance adhesion of the composition to the reinforcement. It should be noted that the term “reinforcement” is meant to encompass both structural and non-structural (e.g., functional) types of materials that are at least partially encased in the composition discharging from head 16.

The reinforcements may be opaque (e.g., partially or completely opaque) to a cure energy, transparent (e.g., partially or completely transparent) to the cure energy, and/or a mixture of opaque and transparent materials. The reinforcement materials may include, for example, carbon fibers, graphite fibers, graphene fibers, resorcinol-formaldehyde blends, asbestos fibers, Kevlar fibers, polybenzimidazole fibers, polysulforamide fibers, glass fibers, poly(phenylene oxide) fibers, vegetable fibers, wood fibers, mineral fibers, plastic fibers, metallic wires, optical tubes, aramid fibers, polyacrylonitrile, rayon, petroleum pitch, natural pitch, resoles, carbon nanotubes, carbon soot, creosote, SiC, boron, WC, butyl rubber, boron nitride, fumed silica, nanoclay, silicon carbide, boron nitride, zirconium oxide, titanium dioxide, chalk, calcium sulfate, barium sulfate, calcium carbonate, silicates (e.g., talc, mica or kaolin, silicas, aluminum hydroxide, magnesium hydroxide, etc.), organic reinforcements (e.g., polymer powders, polymer fibers, etc.), and mixtures thereof.

In one example, the composition may be a carbon precursor (e.g., pyrolyzable to carbon) and used to coat carbon reinforcements, a mixture of carbon and non-carbon reinforcements, ceramic reinforcements, and/or a mixture of ceramic and non-ceramic reinforcements. In another example, the composition may be a ceramic precursor and used to coat carbon reinforcements, a mixture of carbon and non-carbon reinforcements, ceramic reinforcements, and/or a mixture of ceramic and non-ceramic reinforcements. As will be explained in more detail below, non-carbon and/or non-ceramic reinforcements may be selectively used in conjunction with carbon and/or ceramic reinforcements for purposes of creating conduits that enhance saturation of the carbon and/or ceramic reinforcements with the composition.

The reinforcements may be exposed to (e.g., at least partially coated and/or internally wetted with) the composition while the reinforcements are inside head 16, while the reinforcements are passing into head 16, and/or while the reinforcements are discharging from head 16. The composition, dry (e.g., unimpregnated) reinforcements, and/or reinforcements that are already exposed to the composition (pre-impregnated reinforcements) may be transported into head 16 in any manner apparent to one skilled in the art. In some embodiments, discontinuous reinforcements (e.g., powder, nano-particles or tubes, chopped fibers, etc.) may be mixed with the composition and/or additives before and/or after the composition coats continuous reinforcements.

One or more cure enhancers (e.g., a light source, a radiation source, an ultrasonic emitter, a microwave generator, a magnetic field generator, a heater, a catalyst dispenser, etc.) 18 may be mounted proximate (e.g., within, on, and/or adjacent) head 16 and configured to affect (e.g., initiate, enhance, complete, or otherwise facilitate) curing of the composition as it is discharged with the reinforcement(s) from head 16. Each cure enhancer 18 may be independently and/or cooperatively controlled to selectively expose one or more portions of the discharging material to cure energy (e.g., electromagnetic radiation, vibrations, heat, a chemical catalyst, etc.). The energy may trigger a reaction to occur within the composition, increase a rate of the reaction, sinter the composition, pyrolyze the composition, harden the composition, stiffen the composition, or otherwise cause the composition to partially or fully cure and/or char as it discharges from head 16. The amount of energy produced by cure enhancer 18 may be sufficient to at least partially cure the composition before structure 12 axially grows more than a predetermined length away from head 16. In one embodiment, structure 12 is cured sufficient to hold its shape before the axial growth length becomes equal to an external diameter of the composition-coated reinforcement.

The composition and/or reinforcement may be discharged from head 16 via one or more different modes of operation. In a first mode of operation, the composition and/or reinforcement are extruded (e.g., pushed under pressure and/or mechanical force) from head 16, as head 16 is moved by support 14 to create features of structure 12. In a second mode of operation, at least the reinforcement (e.g., a continuous reinforcement) is pulled from head 16, such that a tensile stress is created in the reinforcement during discharge. In this mode of operation, the composition may cling to the reinforcement and thereby also be pulled from head 16 along with the reinforcement. Additionally or alternatively, the composition may be discharged from head 16 under pressure along with the pulled reinforcement. In the second mode of operation, where the composition is being pulled from head 16 with the reinforcement, the resulting tension in the reinforcement may increase a strength of structure 12 (e.g., by aligning the reinforcements, inhibiting buckling, etc.) after curing of the composition, while also allowing for a greater length of unsupported structure 12 to have a straighter trajectory. That is, the tension in the reinforcement may act against the force of gravity (e.g., directly and/or indirectly by creating moments that oppose gravity) to provide support for structure 12. In some embodiments, the tension may also help impregnate the reinforcement with composition (e.g., in pressure-based impregnation applications).

The reinforcement may be pulled from head 16 as a result of head 16 being moved by support 14 away from an anchor (e.g., a print bed, a feature of structure 12, etc.). In particular, at the start of structure formation, a length of composition-impregnated reinforcement may be pulled and/or pushed from head 16, deposited onto the anchor, and cured, such that the discharged material adheres or is otherwise coupled to the anchor. Thereafter, head 16 may be moved away from the anchor, and the relative movement may cause the reinforcement to be pulled from head 16. It should be noted that the movement of reinforcement through head 16 could be assisted via internal feed mechanisms (not shown), if desired. However, the discharge rate of reinforcement from head 16 may primarily be the result of relative movement between head 16 and the anchor, such that tension is created within the reinforcement. It should be noted that the anchor could be moved away from head 16 instead of or in addition to head 16 being moved away from the anchor.

As can be seen in FIG. 1, head 16 may include, among other things, an outlet 22 and a composition reservoir 24 located upstream of outlet 22. In this example, outlet 22 is a single-channel nozzle configured to discharge composite material having a generally circular, tubular, or rectangular cross-section. The configuration of head 16 may, however, may allow outlet 22 to be swapped out for another outlet (not shown) that discharges composite material having a different shape (e.g., a flat or sheet-like cross-section, a multi-track cross-section, etc.). Fibers, tubes, and/or other reinforcements may pass through composition reservoir 24 and be wetted (e.g., at least partially coated, internally wetted, and/or fully saturated) with composition prior to discharge. Any type of wetting mechanism(s) known in the art (e.g., a bath—shown, an injector, a pressure-based applicator, etc.) may be associated with composition reservoir 24.

In one example, a compactor 32 trails outlet 22 (e.g., relative to a normal travel direction of head 16 during material discharge) and moves (e.g., rolls and/or slides) over the material discharging from outlet 22 to compact the material. It is contemplated that either the nozzle of outlet 22 or compactor 32 may function as a tool center point (TCP) of head 16 to affix the composition-wetted reinforcement(s) at a desired location prior to and/or during curing when exposed to energy by cure enhancer(s) 18. It is also contemplated that the nozzle and/or compactor 32 may be omitted, in some embodiments. Finally, it is contemplated that the TCP of head 16 may not necessarily be associated with the nozzle or compactor 32 and instead be a location of cure energy exposure that is separate from these locations. The TCP may also switch locations in some applications.

One or more controllers 23 may be provided and communicatively coupled with support 14 and one or more components of head 16. Each controller 23 may embody a single processor or multiple processors that are specially programmed to control an operation of system 10. Controller 23 may further include or be associated with a memory for storing data such as, for example, design limits, performance characteristics, operational instructions, tool paths, and corresponding parameters of components of system 10. Various other known circuits may be associated with controller 23, including power supply circuitry, signal-conditioning circuitry, solenoid driver circuitry, communication circuitry, and other appropriate circuitry. Moreover, controller 23 may be capable of communicating with other components of system 10 via wired and/or wireless transmission.

One or more maps may be stored in the memory of or otherwise be accessible by controller 23 and used during fabrication of structure 12. Each of these maps may include a collection of data in the form of lookup tables, graphs, and/or equations. In the disclosed embodiment, the maps may be used by controller 23 to determine movements of head 16 required to produce desired geometry (e.g., size, shape, material composition, performance parameters, and/or contour) of structure 12, and to regulate operation of cure enhancer(s) 18 and/or other related components in coordination with the movements.

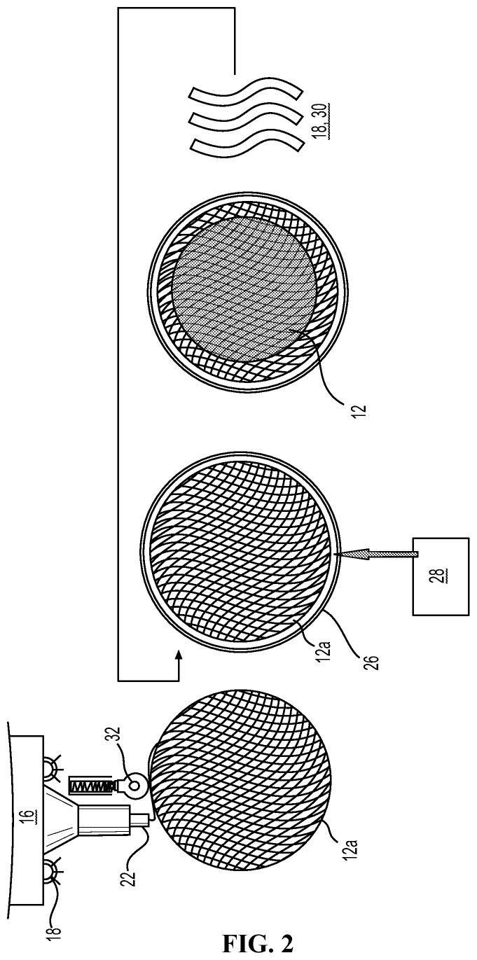

In one embodiment, structure 12 may fabricated by system 10 as a CBFC or a CMC. As shown in FIG. 2, this process may involve multiple steps, although fewer steps than the traditional hand-layup processes described above. In a first step (shown far left image of FIG. 2), composite material may be discharged from head 16 to produce a three-dimensional preform 12a (e.g., a preform of carbon or ceramic fibers at least partially coated in and/or internal wetted with a ceramic or carbon precursor composition). Preform 12a may be fabricated within a mold 26, on a build platform, and/or in free-space (e.g., without a mold or platform) to have a desired net or near-net shape of structure 12. For example, the composition-wetted continuous reinforcement may be adhered to a surface of mold 26, to a surface of the build platform, or to an existing anchor placed or prefabricated at any desired location and orientation. Thereafter, head 16 may be moved by support 14 (referring to FIG. 1) relative to the surface or anchor, thereby causing the composite material to be pulled from head 16 and placed along a desired contour. As the material discharges from head 16, the composition may be at least partially cured (e.g., stiffened sufficient to hold its shape, location and/or orientation) by exposure to energy from cure enhancer(s) 18. In some embodiments, the composition (e.g., a thixotropic resin) may become thick enough after discharge to hold its shape without needing to be cured by enhancer(s) 18. In these embodiments, the initial step of curing may be omitted, if desired.

After preform 12a has been fabricated, preform 12a may selectively be densified. In the embodiment where preform 12a is fabricated inside of mold 26, a densifying material (e.g., a carbon or ceramic precursor) may be introduced into mold 26 as a liquid and/or a gas (e.g., by a corresponding supply 28—shown in the middle image of FIG. 2). The densifying material may be the same as the composition originally used to fabricate preform 12a or a different composition, as desired. The densifying material may adhere to the previously discharged material and fill voids therein and/or therebetween. When preform 12a is fabricated on a build platform or in free-space, preform 12a may be densified in the same location or transferred into mold 26 or into a specially prepared densification chamber (not shown) prior to densification. Heat and/or pressure may be utilized to enhance infiltration of the densifying material into the voids and spaces of preform 12a.

It is contemplated that a first degree of densification may be performed in situ during fabrication of preform 12a, if desired. For example, supply 28 may be operatively connected to head 16 at a trailing location (e.g., downstream of cure enhancer(s) 18 and/or compactor 32), to advance the densification material toward the portion of preform 12a being discharged from head 16 and cured by cure enhancer(s) 18. As will be explained in more detail below, this may eliminate one or more steps in the fabrication of structure 12. In this embodiment, it may be possible for the composition first applied to the reinforcement inside of head 16 to only be a minimum amount required to hold a shape of the reinforcement during the immediately ensuing densification step.

After the application of densifying material, preform 12a may be pyrolyzed (shown in the right image of FIG. 2). That is, preform 12a and the added densifying material (or preform 12a only with the in-head applied composition) may be exposed to elevated temperatures (e.g., to temperatures of about 400-3000° C., such as 400-500° C. or 500-1500° C.) that causes the densifying material and/or the in-head applied composition to carbonize into char. In one example, the elevated temperatures are generated by a dedicated heating device 30. In one application, heating device 30 is a component located offboard head 16 (e.g., in a dedicated chamber). In another application, heating device 30 is operatively connected to head 16 at a location downstream of supply 28 and configured to pyrolyze the densifying material in situ during fabrication of preform 12a. In an alternative embodiment, one or more of cure enhancer(s) 18 may function to both cure and pyrolyze the densifying material in place of or in addition to heating device 30, if desired. That is, the process of curing the composition to hold the shape of preform 12a could additionally at least partially pyrolyze the composition.

Without wishing to be bound by any theory, carbonization due to pyrolysis may include polymerization and growth of the composition, which results in desirable carbon enrichment of preform 12a. It should be noted that pyrolization may be enhanced when performed within a controlled environment (e.g., in the absence of oxygen). Accordingly, in the above embodiments, where heating device 30 is located offboard head 16 and inside of a chamber, the chamber may be evacuated of oxygen and/or filled with an inert gas (e.g., argon, helium, nitrogen, etc.). Alternatively, when heating device 30 is mounted to head 16, a flow of the inert gas from an onboard source may be directed over the discharging material.

When heating device 30 is located offboard head 16, pyrolization may occur only when all of the structure of preform 12a has been completed or periodically as select portions (e.g., each layer) of preform 12a have been completed. In either of these scenarios, fabrication of preform 12a may be performed inside of the chamber or outside. When fabrication is performed outside of the chamber, preform 12a may selectively be transferred into the chamber after each select portion has been discharged and cured, and then transferred back out of the chamber after each pyrolization event.

It is contemplated that pyrolization may be completed before or after a first application of the densifying material. That is, heating device 30 and/or cure enhancer(s) 18 may be selectively activated by controller 23 to at least partially carbonize or burn away the composition holding the structure of preform 12a together, prior to the first application of the densifying material. This may help reduce a number of steps required in the process of fabricating structure 12, particularly when the composition holding preform 12a together is different from the densifying material.

As preform 12a is heated (e.g., with or without the densifying material), the associated composition and/or densifying material may shrink, crack, or otherwise become porous. In order to provide a desired density to structure 12, multiple cycles of material application and pyrolyzing may be required. Any number of these cycles may be implemented.

Although densification may help to reduce porosity within preform 12a, this may only be true when access to corresponding pores and voids is available. Accordingly, in some applications, one or more agents may optionally be included within the disclosed composition to prevent and/or reduce undesirable volatiles that are trapped within preform 12a following pyrolysis. Non-limiting examples of these agents include plasticizers such as ethylenebis(stearamide), stearic acid, oleic acid, any and all glycols, and mixtures thereof. Other non-limiting examples include: avocado oil, almond oil, olive oil, cacao oil, beef tallow, sesame oil, wheat germ oil, safflower oil, shea butter, turtle oil, persimmon oil, persic oil, castor oil, grape oil, macadamia nut oils such as mink oil, egg yolk oil, owl, palm oil, rosehip oil, hydrogenated oil; wax such as orange luffy oil, carnauba wax, candelilla wax, whale wax, jojoba oil, montan wax, beeswax, lanolin, lanolin hydrocarbons such as liquid paraffin, petrolatum, paraffin, ceresin, microcrystalline wax, squalane; lauric acid, myristic acid, palmitic acid, stearic acid, oleic acid, behenic acid, undecylenic acid, oxystearic acid, linoleic acid, lanolin fatty acid, higher fats such as synthetic fatty acids, higher alcohols such as lauryl alcohol, cetyl alcohol, cetostearyl alcohol, stearyl alcohol, oleyl alcohol, behenyl alcohol, lanolin alcohol, hydrogenated lanolin alcohol, octyldodecanol and isostearyl alcohol; sterols such as cholesterol, dihydrocholesterol and phytosterol; linoleic acid ester, isopropyl myristate, lanolin fatty acid isopropyl, hexyl laurate, myristyl myristate, cetyl myristate, octyldodecyl myristate, decyl oleate, octyldodecyl oleate, hexyldecyl dimethyloctanoate, cetyl isooctanoate, palmitic acid cetyl, trimyristin glycerin, tri (capryl/capric acid) catty acid esters such as glycerol, propylene glycol dioleate, glycerol triisostearate, glycerol triisooctanoate, cetyl lactate, myristyl lactate, diisostearyl malate; polyhydric alcohols such as ethylene glycol, propylene glycol, trimethylene glycol, 1, 2-butylene glycol, 1,3-butylene glycol, tetramethylene glycol, 2,3-butylene glycol, pentamethylene glycol, 2-butene-1,4-diol, hexylene glycol, octylene glycol and the like alcohol; trivalent alcohol such as glycerin, trimethylolpropane, 1,2,6-hexanetriol; tetravalent alcohol such as pentaerythritol; pentavalent alcohol such as xylitol hexavalent alcohols such as sorbitol and mannitol, polyhydric alcohols such as diethylene glycol, dipropylene glycol, triethylene glycol, polypropylene glycol, tetraethylene glycol, diglycerin, polyethylene glycol, triglycerin, tetraglycerin and polyglycerin copolymer; ethylene glycol monomethyl ether, ethylene glycol monoethyl ether, ethylene glycol monobutyl ether, ethylene glycol monophenyl ether, ethylene glycol monohexyl ether, ethylene glycol mono 2-methylhexyl ether, ethylene glycol isoamyl ether, ethylene glycol benzyl ether, ethylene diglycol isopropyl ether, ethylene glycol di-divalent alcohol alkyl ethers such as chill ether, ethylene glycol diethyl ether, ethylene glycol dibutyl ether; diethylene glycol monomethyl ether, diethylene glycol monoethyl ether, diethylene glycol monobutyl ether, diethylene glycol dimethyl ether, diethylene glycol diethyl ether, diethylene glycol butyl ether, diethylene glycol methyl ethyl ether, triethylene glycol ethylene glycol monomethyl ether, triethylene glycol monoethyl ether, propylene glycol monomethyl ether, propylene glycol monoethyl ether, propylene glycol monobutyl ether, propylene glycol isopropyl ether, dipropylene glycol dihydric alcohol alkyl ethers such as dimethyl ether, dipropylene glycol ethyl ether, dipropylene glycol butyl ether; ethylene glycol monomethyl ether acetate, ethylene glycol monoethyl ether acetate, ethylene glycol monobutyl ether acetate, ethylene glycol monophenyl ethyl acetate, ethylene glycol diazebate, ethylene glycol disuccinate, diethylene glycol monoethyl ether acetate, diethylene glycol monobutyl ether acetate, propylene glycol monomethyl ether acetate, propylene glycol monoethyl ether acetate, propylene glycol monopropyl ether acetate, propylene glycol mono dihydric alcohol ether esters such as phenyl ether acetate; Glycerin monoalkyl ethers such as xyl alcohol, ceralkyl alcohol, batyl alcohol, sorbitol, maltitol, maltotriose, mannitol, sucrose, erythritol, glucose, fructose, amylolytic sugar, maltose, xylitol, amylolytic sugar-reducing alcohols, glycolide, tetrahydrofurfuryl alcohol, POE tetrahydrofurfuryl alcohol, POP butyl ether, POP/POE butyl ether, tripolyoxypropylene glycerin ether, POP glycerin ether, POP, glycerin ether phosphoric acid and POP/POE pentaerythritol ether.

For purposes of cost and efficiency, it is desirable to maximize an amount of carbon present in the form of char within preform 12a after a minimal number of the pyrolysis steps. Accordingly, in some applications, the composition and/or composition/reinforcement composite material may additionally include one or more non-curable char-forming constituents. These constituents may be selected from the group consisting of tar pitches, petroleum products, non-functionalized novolaks, carbore, lignin, pitch, lignite, tar, creosote, and/or mixtures thereof. Additionally or alternatively, the composition and/or composition/reinforcement composite material may include non-reactive additives that contribute to forming or otherwise increasing an amount of the char remaining in preform 12a after the pyrolysis step. Non-limiting examples of the non-reactive additives are carbon felts, fiberform insulation, graphite additives, acrylonitrile butadiene rubber (BNR), ethylene propylene diene monomer rubber (EPDM), etc.

Elastomers may optionally be included in the compositions disclosed herein to impart flexibility to the composite during the pyrolysis step. Enhanced flexibility may help to reduce residual stress caused by expanding volatiles that are unable to escape from preform 12a. The flexibility may also help to reduce residual stress caused by thermal gradients from curing and/or pyrolysis and subsequent cooling of structure 12. Non-limiting examples of such additives include dissolved or particulate acrylonitrile butadiene rubber (BNR) and ethylene propylene diene monomer rubber (EPDM).

Once a desired density within structure 12 has been achieved, the process of fabrication may be completed. That is, structure 12 may have a desired shape and size, without machining being required. In some instances, however, structure 12 may be intentionally oversized and light machining may be helpful to precisely achieve the desired shape and/or size within a required tolerance.

### INDUSTRIAL APPLICABILITY

The disclosed system may be used via the disclosed methods to manufacture composite structures having any desired cross-sectional shape, length, density, strength, or other desired performance parameter. The composite structures may include any number of different reinforcements of the same or different types, diameters, shapes, configurations, and consists, and any number and types of different compositions. The disclosed system may be particularly applicable to fabrication of CBFCs, CMCs, and other high-temperature composite components.

An operational overview of system 10 will now be described. At a start of a manufacturing event, information regarding a desired structure 12 to be fabricated may be loaded into system 10 (e.g., into controller 23 that is responsible for regulating operation of support 14, head 16, cure enhancer(s) 18, supply 28, and/or heating device 30). This information may include, among other things, a size (e.g., diameter, wall thickness, length, etc.), a contour (e.g., a trajectory), surface features (e.g., ridge size, location, thickness, length; flange size, location, thickness, length; etc.), connection geometry (e.g., locations and sizes of couplings, tees, splices, etc.), location-specific composition stipulations, location-specific reinforcement stipulations, desired cure rates, cure locations, cure parameters, desired pyrolization rates, pyrolization locations, pyrolization parameters, additive specifications, filler specifications, etc. It should be noted that this information may alternatively or additionally be loaded into system 10 at different times, periodically, and/or continuously during the manufacturing event, if desired.

Based on the component information, one or more different (e.g., different sizes, shapes, numbers, and/or types of) reinforcements, compositions, additives, and/or fillers may be selectively installed within system 10, supplied into reservoir 24, and/or directed into supply 28. For example, a tow of carbon and/or ceramic fiber may be threaded through outlet 22 of head, and a carbon and/or ceramic precursor composition may fill composition reservoir 24 and/or supply 28. Controller 23 may then selectively activate a wetting mechanism inside of reservoir 24, an onboard and/or offboard embodiment of supply 28, cure enhancer(s) 18, support 14, and/or an onboard and/or offboard embodiment of heating device 30, such that the continuous reinforcement passing through head 16 is appropriately coated and/or internally wetted with the composition and/or a different densifying material, pulled from head 16, cured to form a shape of preform 12a, densified, and/or pyrolyzed.

In one specific example (EX-1 shown below), the composition directed into head 16 and discharged along with the reinforcement includes (meth)acrylated novolaks as oligomers derived from formaldehyde-phenol type novolaks. The composition may be capable of curing with actinic (e.g., UV) radiation and provide for high-carbon yield during subsequent pyrolysis. For the purposes of this disclosure, actinic radiation may be considered light that is capable of initiating a photochemical reaction within the composition.

The exemplary composition may also include reactive diluent monomers, which are also capable of curing with actinic radiation. These reactive diluent monomers may maintain a viscosity of the composition within one or more ranges suitable for additive manufacturing processes. For example, it may be desirable for the curable composition to have a viscosity that is less than 60,000 mPa·s at 25° C. For example, the curable composition may have a viscosity of at most 120,000 mPa·s, at most 100,000 mPa·s, at most 90,000 mPa·s, at most 80,000 mPa·s, at most 70,000 mPa·s, at most 65,000 mPa·s, at most 60,000 mPa·s, at most 55,000 mPa·s, at most 50,000 mPa·s, at most 45,000 mPa·s, at most 40,000 mPa·s, at most 35,000 mPa·s, at most 30,000 mPa·s, at most 25,000 mPa·s or at most 20,000 mPa·s at 25° C., as measured using a Brookfield viscometer, model DV-II, using a 27 spindle (with the spindle speed varying typically between 20 and 200 rpm, depending on viscosity).

EX-1 is a curable composition comprising:
a) at least one aromatic, actinically curable component having an H/C_{atomic ratio} of from 0.4 to 1.6, selected from the group consisting of (meth)acrylate oligomers, epoxy-functionalized compounds, oxetane-functionalized compounds and mixtures thereof,
b) at least one diluent comprising at least one actinically curable monomer;
c) an at least partially opaque reinforcement; and
d) a photoinitiator.

The composition of EX-1 has been developed to preferably create more than 18 weight % char from pyrolysis, as measured by thermogravimetric analysis (TGA) after a 3-hour hold at 400° C., based on the weight of the a), b) and d) after actinically curing (i.e., prior to pyrolysis). It should be understood that, in some applications, a TGA apparatus may serve to pyrolyze the actinically cured combination of the a), b) and d), as well as to measure the weight % char, exclusive of the reinforcement. For example, the composition may create more than 20 weight %, or more than 22.5 weight %, or more than 25 weight %, or more than 30 weight %, or more than 35 weight %, or more than 40 weight %, or more than 45 weight %, or more than 50 weight % char from pyrolysis, as measured by TGA after the 3-hour hold at 400° C., based on the weight of the a), b) and d) after actinically curing. The reinforcement is not included in the measured amount of char. The weight % char after pyrolysis measured by the TGA apparatus may therefore be based on the total weight of the cured composition excluding the amount of the c), prior to pyrolysis in the TGA apparatus.

In one application, the measurement of the weight % char is carried out as follows. The weight % char of a small amount of actinically cured composition (10-30 mg of resin without reinforcement) may be measured (e.g., using a TA Instruments Q50 TGA). The following heating procedure may then be used for pyrolysis: ramp from room temperature to 300° C. at a ramp rate of 5° C./min, ramp from 300° C. to 400° C. at 1° C./min, hold at 400° C. for 3 hours, ramp from 400° C. to 500° C. at 1° C./min, hold at 500° C. for 3 hours, and finally ramp from 500° C. to 1000° C. after which pyrolysis is ended. A continuous flow of 40-60 mL/min of nitrogen may be used as an inert purge gas throughout the heating procedure. The weight % char at a given temperature can then be determined as a percentage of residual material weight divided by the weight of the small amount recorded at the start of pyrolysis. Preferably, the weight % char value reported is taken as the weight % remaining at the end of either the 3-hour holding period at 400° C. or the 3-hour holding period at 500° C.

Regarding the weight % char, it should be understood that it represents the amount of char that is present after a first pyrolysis of only the composition (i.e., not including a weight of reinforcement) that will be made into a carbon-bonded-carbon or carbon-bonded-ceramic composite. As described above, a more complete process may involve subsequent repeated cycles of densification with char-forming materials and pyrolysis.

It should be noted that Hydrogen/Carbon atomic ratios (H/C_{atomic ratio}) and Aromatic Content (AC) may be structural descriptors for establishing a structure-property relationship between resin feedstocks in the composition and their ability to serve as sacrificial materials for high-yield carbonization in carbon-bonded composites.

The H/C_{atomic ratio} is defined as the number of hydrogen atoms in a given molecule divided by the number of carbon atoms in the same molecule. The H/C_{atomic ratio} does not consider heteroatoms (e.g., O, S, N, P) in a molecule. The H/C_{atomic ratio}, for the purposes of this disclosure, may be used to evaluate unreacted actinically-curable components, monomers, and additives. Lower values of H/C_{atomic ratio} may be more ideal and H/C_{atomic ratio} theoretically trends close to 0 for graphite. Thus, it may be understood that H/C_{atomic ratio} may be related to an aromaticity of the composition.

The H/C_{atomic ratio} of a mixture of compounds corresponds to the weight average H/C_{atomic ratio} of the mixture. For a mixture comprising a number n of compounds, the weight average H/C_{atomic ratio} of the mixture may be calculated with the following equation:

$$H / {C}_{atomic r𝔠ιtio} = {\sum }_{i = 1}^{n} {w}_{i} \times H / {C}_{i}$$

wherein wᵢ is the mass fraction of compound i in the mixture (mass of compound i divided by the total mass of the mixture); H/Cᵢ is the H/C_{atomic ratio} of compound i.

The Aromatic Content (AC) is used to describe unreacted actinically-curable components, monomers, and additives. The AC value, for the purposes of this disclosure, may be understood to be an average number of aromatic rings per molecule. Aromatic in the traditional sense is defined by IUPAC as having a chemistry typified by benzene. AC, as used in this disclosure, is meant as an actinically cured monomer, component or additive containing a single or multiple benzene rings in any configuration (e.g., monocyclics, fused rings, polycyclics, bridged), and any single or combination of substitutions (ortho, meta, para, etc.). This disclosure does not limit benzene ring content to other benzene rings, but additionally includes configurations of benzene rings fused with heterocycles, carbocyclics, epoxy rings, and oxetane rings within a single actinically-curable monomer, component or additive. For example, a benzene ring fused with another ring would be included in this definition. For example, 7-hydroxycoumarin that is functionalized with an acrylic group would fall within the present definition of an aromatic species useful in the present disclosure.

The Aromatic Content (AC) value of a mixture of compounds corresponds to the weight average AC value of the mixture. For a mixture comprising a number n of compounds, the weight average AC value of the mixture may be calculated with the following equation:

$$A C = {\sum }_{i = 1}^{n} {w}_{i} \times A {C}_{i}$$

wherein wᵢ is the mass fraction of compound i in the mixture (mass of compound i divided by the total mass of the mixture); ACᵢ is the AC value of compound i.

As used herein, (meth)acrylated substances may be referred to as “monomers” (i.e., the b) in EX-1 above) if they may be formed by reaction of a hydroxyl group with (meth)acrylic acid (or ester) in a condensation reaction. (Meth)acrylated substances may be referred to as “oligomers” (i.e., the a) in EX-1 above), if they may be formed by addition reactions to epoxy compounds, isocyanates, etc. Accordingly, polyethylene glycol diacrylate and ethoxylated bisphenol A diacrylate would be monomers, even though they have ethylene oxide repeating units whereas bisphenol A diglycidyl ether diacrylate is an oligomer, even though it has no repeat units.

In the example composition, the combination of the a) selected from the group consisting of (meth)acrylate oligomers, epoxy-functionalised compounds and mixtures thereof; and the b) may have an H/C_{atomic ratio} of from 0.4 to 1.6. For example the H/C_{atomic ratio} of the a) and the b) together in the example composition (i.e., the net H/C_{atomic ratio} of the a) and the b)) may be from 0.5 to 1.5, from 0.6 to 1.3, from 0.7 to 1.4, from 0.8 to 1.3, from 0.9 to 1.2, from 1.0 to 1.1. For instance, the a) and the b) may each have a net H/C_{atomic ratio} of from 0.4 to 1.6. For example, the H/C_{atomic ratio} of the a) may be from 0.5 to 1.5, from 0.6 to 1.3, from 0.7 to 1.4, from 0.8 to 1.3, from 0.9 to 1.2, from 1.0 to 1.1; and in addition the H/C_{atomic ratio} of the b) may be from 0.5 to 1.5, from 0.6 to 1.3, from 0.7 to 1.4, from 0.8 to 1.3, from 0.9 to 1.2, from 1.0 to 1.1.

According to one embodiment, the composition may include a (meth)acrylated epoxy novolak resin as the a). The composition may also include at least one actinically curable monomer diluent as the b). The b) may be selected from the group consisting of an ethoxylated bisphenol A diacrylate (in particular ethoxylated3 bisphenol A diacrylate), 2-phenoxyethyl acrylate, tert-butylcyclohexyl acrylate, tricyclodecane dimethanol diacrylate, tris(2-hydroxy ethyl)isocyanurate triacrylate, mono- or polyoxyethylene p-cumylphenyl ether acrylate, trimethylolpropane triacrylate, and mixtures thereof. The composition may further include a phosphine oxide, in particular phenylbis(2,4,6-trimethylbenzolyl)phosphine oxide as the d).

According to another embodiment, the a) is a (meth)acrylated phenol-based epoxy novolak. According to further embodiments, the a) is preferably a phenol/formaldehyde-based acrylated epoxy novolak resin. In either of these embodiments, the b) may be 35 weight % 2-phenoxyethyl acrylate and 10 weight % tris(2-hydroxy ethyl)isocyanurate triacrylate, by weight in the overall composition of the a) and the b). In this embodiment, the c) may be a continuous reinforcement.

The a) comprises, consists of or consists essentially of at least one aromatic, actinically curable component. The a) may comprise, consist of or consist essentially of a mixture of aromatic, actinically curable components.

The a) comprises, consists of or consists essentially of at least one aromatic, actinically curable component selected from the group consisting of (meth)acrylate oligomers, epoxy-functionalized compounds, oxetane-functionalized compounds and mixtures thereof.

The a) may comprise, consist of or consist essentially of at least one aromatic, actinically curable component comprising at least one (meth)acrylate group, in particular at least two (meth)acrylate groups. The a) may comprise, consist of or consist essentially of at least one aromatic, actinically curable component comprising at least one acrylate group, in particular at least two acrylate groups. The a) may comprise, consist of or consist essentially of at least one aromatic (meth)acrylate oligomer comprising at least two (meth)acrylate groups, in particular more than two (meth)acrylate groups. The a) may comprise, consist of or consist essentially of at least one aromatic (meth)acrylate oligomer comprising at least two acrylate groups, in particular more than two acrylate groups.

The a) may comprise, consist of or consist essentially of at least one (meth)acrylated aromatic epoxy resin. As used herein, the term “(meth)acrylated aromatic epoxy resin” means the reaction product of at least one aromatic epoxy resin and (meth)acrylic acid. As used herein, the term “aromatic epoxy resin” means an aromatic compound comprising at least one epoxy group, in particular at least two epoxy groups, more particularly more than two epoxy groups. The a) may comprise, consist of or consist essentially of at least one (meth)acrylated aromatic glycidyl ether resin. As used herein, the term “(meth)acrylated aromatic glycidyl ether resin” means the reaction product of at least one aromatic glycidyl ether resin and (meth)acrylic acid. As used herein, the term “aromatic glycidyl ether resin” means an aromatic compound comprising at least one glycidyl ether group, in particular at least two glycidyl ether groups. As used herein, the term “glycidyl ether group” means a group of the following formula (I):

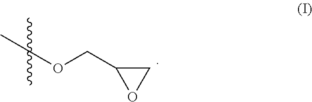 [SMILES: *OCC1CO1]

The a) may comprise, consist of or consist essentially of at least one (meth)acrylated aromatic glycidyl ether resin selected from a (meth)acrylated epoxy novolak resin, a (meth)acrylated bisphenol-based diglycidyl ether and mixtures thereof.

In one embodiment, the a) may comprise, consist of or consist essentially of at least one (meth)acrylated epoxy novolak resin. The (meth)acrylated epoxy novolak resin may have an average number of (meth)acrylate groups of 1 to 15, in particular 2 to 10. The epoxy novolak resin used to obtain the (meth)acrylated epoxy novolak resin may be a phenol-based epoxy novolak resin, a bisphenol-based epoxy novolak resin or a cresol-based epoxy novolak resin, more particularly a phenol-based epoxy novolak resin.

An epoxy novolak resin may be represented by the following formula (II)

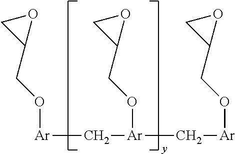

wherein
Ar is an aromatic linker, in particular phenylene, tolylene or an optionally substituted diphenylmethane divalent radical;
y is 0 to 50.

In one embodiment, the a) may comprise, consist of or consist essentially of at least one (meth)acrylated bisphenol-based diglycidyl ether. The bisphenol-based diglycidyl ether used to obtain the (meth)acrylated bisphenol-based diglycidyl ether may be represented by the following formula (III):

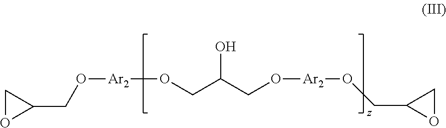

wherein
Ar₂ is a linker of formula (IV)

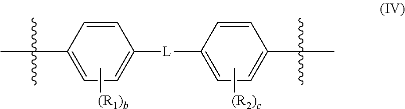

wherein L is a linker;
R₁ and R₂ are independently selected from alkyl, cycloalkyl, aryl and a halogen atom;
b and c are independently 0 to 4; and
z is 0 to 50.

In particular, L may be a linker selected from bond, —CR₃R₄—, —C(═O)—, —SO—, —SO₂—, —C(═CCl₂)— and —CR₅R₆-Ph-CR₇R₈—;

wherein:
R₃ and R₄ are independently selected from H, alkyl, cycloalkyl, aryl, haloalkyl and perfluoroalkyl, or R₃ and R₄, with the carbon atoms to which they are attached, may form a ring;
R₅, R₆, R₇ and R₈ are independently selected from H, alkyl, cycloalkyl, aryl, haloalkyl and perfluoroalkyl;
Ph is phenylene optionally substituted with one or more groups selected from alkyl, cycloalkyl, aryl and a halogen atom.

More particularly, Ar₂ may be the residue of a bisphenol without the OH groups. A compound according to formula (III) wherein Ar₂ is the residue of a bisphenol without the OH groups may be referred to as a bisphenol-based diepoxy ether, preferably a bisphenol-based diglycidyl ether. Examples of suitable bisphenols are bisphenol A, bisphenol AP, bisphenol AF, bisphenol B, bisphenol BP, bisphenol C, bisphenol C2, bisphenol F, bisphenol G, bisphenol M, bisphenol S, bisphenol P, bisphenol PH, bisphenol TMC, bisphenol-Z, dinitrobisphenol A, tetrabromobisphenol A and combinations thereof.

In some embodiments, the H/C_{atomic ratio} of the a) in EX-1 may be from about 0.4 to 1.6. For example, the H/C_{atomic ratio} may be from 0.7 to 1.4. The a) comprises at least one aromatic, actinically curable component having an H/C_{atomic ratio} of from 0.4 to 1.6, from 0.5 to 1.5, from 0.6 to 1.4, from 0.7 to 1.4, from 0.8 to 1.3, from 0.9 to 1.2 or from 1.0 to 1.1. If the a) comprises a mixture of aromatic, actinically curable components, the weight average H/C_{atomic ratio} of the a) may be from 0.4 to 1.6, from 0.5 to 1.5, from 0.6 to 1.4, from 0.7 to 1.4, from 0.8 to 1.3, from 0.9 to 1.2 or from 1.0 to 1.1.

The a) may have an AC of at least 1. For example, the AC may be at least 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 65.5, 6, 6.5, 7, 7.5, 8, 8.5, 9, 9.5, or have at least 10 aromatic rings per molecule on average. The a) may comprise at least one aromatic, actinically curable component having an AC value of at least 1, at least 2, at least 3, at least 4, at least 5, at least 6, at least 7, at least 8, at least 9 or at least 10. If the a) comprises a mixture of aromatic, actinically curable components, the weight average AC value of the a) may be at least 1, at least 2, at least 3, at least 4, at least 5, at least 6, at least 7, at least 8, at least 9 or at least 10.

The a) may include at least one phenolic moiety (i.e. an oxygen directly bonded to at least one aromatic ring). The phenolic moiety may include a backbone of phenol formaldehyde resin with a formaldehyde:phenol molar ratio of less than 1. A novolak resin modified with at least one (meth)acrylate group is a non-limiting example of such a structure that contains phenolic moieties. As used herein, “novolak” resins modified with at least one (meth)acrylate group may be based on hydroxyl aromatic structures such as, but not limited to, phenolics, bisphenol-based, bisphenol A-based, or cresol-based, for example.

According to an embodiment, the a) of EX-1 is preferably a (meth)acrylated phenol-based epoxy novolak resin. According to further embodiments, the a) may be an acrylated phenol/formaldehyde-based epoxy novolak resin.

According to other embodiments, the a) may be present in the composition at 5 to 95 weight %, based on the total weight of the a) and the b) in the composition. For example, the a) may be present at from 10-90 weight %, from 15-85 weight %, from 20-80 weight %, from 25-75 weight %, from 30-70 weight %, from 35-65 weight %, or from 40-60 weight % based on the total weight of the a) and the b) in the composition.

The a) may include at least one (meth)acrylate group per molecule. As used herein the term, “(meth)acrylate” in understood to encompass either or both methacrylate group and acrylate group. As is known in the art, (meth)acrylate groups are capable of curing with actinic radiation in the presence of a free-radical generating photo-initiator. The a) may include at least one acrylate group per molecule, at least two (meth)acrylate groups per molecule, or at least two acrylate groups per molecule.

Epoxy groups and/or oxetane groups are also contemplated as the actinically curable group on the a) of EX-1. For example, the a) may include at least one epoxy group and/or at least one oxetane group per molecule. Such groups may be capable of curing with actinic radiation in the presence of a cation-generating photo-initiator. The a) may comprise, consist of or consist essentially of at least one aromatic, actinically curable component comprising at least one epoxy group and/or at least one oxetane group per molecule. The a) may include at least one epoxy group and/or at least one oxetane group per molecule and at least one (meth)acrylate group per molecule. The a) may comprise, consist of or consist essentially of at least one aromatic, actinically curable component comprising at least one epoxy group and/or at least one oxetane group per molecule and further comprising at least one (meth)acrylate group per molecule. The a) may include a first compound containing at least one epoxy group and/or at least one oxetane group per molecule and a second compound containing at least one (meth)acrylate group per molecule. Component a) may comprise, consist of or consist essentially of a first aromatic, actinically curable component comprising at least one epoxy group and/or at least one oxetane group per molecule and a second aromatic, actinically curable component comprising at least one (meth)acrylate group per molecule.

The a) may further include other ethylenically unsaturated functional groups that are capable of curing with actinic radiation. Non-limiting examples, such as vinylics, styrenics, or malonates, in addition to or as alternatives to (meth)acrylate groups are contemplated according to some embodiments of the disclosure.

Non-limiting particular examples of suitable aromatic actinically curable oligomers are: (meth)acrylated novolak oligomers, such as the following structure:

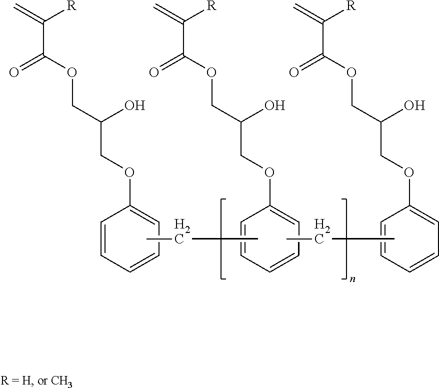

The (meth)acrylated novolak oligomer may have an average number of (meth)acrylate groups of 1 to 15, in particular 2 to 10.

Other non-limiting examples suitable for the a) in EX-1 may include (meth)acrylate esters of lignin, pitch, lignite, tar, creosote, as well as mixtures of any or all of these. Non-limiting examples of epoxy (meth)acrylates suitable for the a) include the reaction products of acrylic or methacrylic acid or mixtures thereof with an epoxy resin (glycidyl ether or ester). The epoxy (meth)acrylates may, in particular, be selected from the reaction products of acrylic or methacrylic acid or mixtures thereof with bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resin, and mixtures thereof.

Epoxy functionalized compounds (i.e., cationically initiated polymerizable compounds) suitable for use as the a) of EX-1 may include, but are not limited to, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether and mixtures thereof.

Oxetane-functionalized compounds (i.e., cationically initiated polymerizable compounds) suitable for use as the a) of EX-1 include, but are not limited to 1,4-Bis[(3-ethyl-3-oxetanylmethoxy)methyl]benzene, 4,4-Bis(3-ethyl-3-oxetanyl)methoxymethyl]biphenyl and mixtures thereof.

The b) of EX-1 comprises, consists of or consists essentially of at least one actinically curable monomer. The b) may comprise, consist of or consist essentially of a mixture of actinically curable monomers. The b) is distinct from the a).

The b) may comprise, consist of or consist essentially of at least one actinically curable monomer having at least one (meth)acrylate group per molecule. The b) may comprise, consist of or consist essentially of at least one actinically curable monomer having at least one acrylate group per molecule. The b) may comprise, consist of or consist essentially of at least one actinically curable monomer having at least two (meth)acrylate group per molecule. The b) may comprise, consist of or consist essentially of at least one actinically curable monomer having at least two acrylate group per molecule. The b) may comprise, consist of or consist essentially of at least one actinically curable monomer having 3, 4, 5, or 6 (meth)acrylate groups per molecule.

The b) of EX-1 may include at least one (meth)acrylate group per molecule. As used herein, the term “(meth)acrylate” is understood to encompass either or both methacrylate group and acrylate group. As is known in the art, (meth)acrylate groups are capable of curing with actinic radiation in the presence of a free-radical generating photo-initiator. The b) may include at least one acrylate group per molecule, at least two (meth)acrylate groups per molecule, or at least two acrylate groups per molecule. The b) may be aromatic. The b) may include 3, 4, 5, or 6 (meth)acrylate groups per molecule.

In some embodiments, the H/C_{atomic ratio} of the b) of EX-1 may be from about 0.4 to 1.6. For example, the H/C_{atomic ratio} of the b) may be from 0.7 to 1.4. For example the H/C_{atomic ratio} of the b) may be from 0.5 to 1.5, from 0.6 to 1.3, from 0.7 to 1.4, from 0.8 to 1.3, from 0.9 to 1.2, or from 1.0 to 1.1. The b) may comprise at least one actinically curable monomer having an H/C_{atomic ratio} of from 0.4 to 1.6, from 0.5 to 1.5, from 0.6 to 1.4, from 0.7 to 1.4, from 0.8 to 1.3, from 0.9 to 1.2 or from 1.0 to 1.1. If the b) comprises a mixture of actinically curable monomers, the weight average H/C_{atomic ratio} of the b) may be from 0.4 to 1.6, from 0.5 to 1.5, from 0.6 to 1.4, from 0.7 to 1.4, from 0.8 to 1.3, from 0.9 to 1.2 or from 1.0 to 1.1.

The b) may have an AC of at least 1. For example, the AC of the b) may be at least 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 65.5, 6, 6.5, 7, 7.5, 8, 8.5, 9, 9.5, or have at least 10 aromatic rings per molecule on average. The b) may comprise at least one actinically curable monomer having an AC value of at least 1 or at least 2. If the b) comprises a mixture of actinically curable monomers, the weight average AC value of the b) may be at least 0.30, at least 0.35, at least 0.40, at least 0.45, at least 0.50, at least 0.55, at least 0.60, at least 0.65, at least 0.70, at least 0.75, at least 0.80, at least 0.85, at least 0.90, at least 1.0, at least 1.1, at least 1.2, at least 1.3, at least 1.4, at least 1.5, at least 1.6, at least 1.7, at least 1.8, at least 1.9 or at least 2.0.

According to an embodiment, the b) may comprise, consist of or consist essentially of at least one actinically curable monomer selected from the group consisting of an ethoxylated bisphenol A diacrylate, 2-phenoxyethyl acrylate, tert-butylcyclohexyl acrylate, tricyclodecane dimethanol diacrylate, tris(2-hydroxy ethyl)isocyanurate triacrylate, mono- or polyoxyethylene p-cumylphenyl ether acrylate, trimethylolpropane triacrylate, and mixtures thereof.

According to an embodiment, the b) of EX-1 may be selected from the group consisting of an ethoxylated bisphenol A diacrylate (in particular ethoxylated3 bisphenol A diacrylate), 2-phenoxyethyl acrylate, tert-butylcyclohexyl acrylate, tricyclodecane dimethanol diacrylate, tris(2-hydroxy ethyl)isocyanurate triacrylate, mono- or polyoxyethylene p-cumylphenyl ether acrylate, trimethylolpropane triacrylate, and mixtures thereof.

The b) may be present in the actinically curable composition at 5 to 95 wt %, based on the total weight of the a) and the b) in the composition. For example, the b) may be present at from 10-90 wt %, from 15-85 wt %, from 20-80 wt %, from 25-75 wt %, from 30-70 wt %, from 35-65 wt %, from 40-60 wt %, based on the total weight of the a) and the b) in the composition.

The b) may comprise, consist of or consist essentially at least one aromatic actinically curable monomer. Preferably, the b) comprises, consists of or consists essentially at least one aromatic actinically curable monomer and optionally one or more non-aromatic actinically curable monomers. The at least one aromatic actinically curable monomer may be selected from the group consisting of an ethoxylated bisphenol A diacrylate, 2-phenoxyethyl acrylate, mono- or polyoxyethylene p-cumylphenyl ether acrylate, and mixtures thereof. The optional non-aromatic actinically curable monomer may be a cyclic monomer, i.e a monomer comprising at least one non-aromatic ring. The optional non-aromatic actinically curable monomer may be selected from the group consisting of tert-butylcyclohexyl acrylate, tricyclodecane dimethanol diacrylate, tris(2-hydroxy ethyl)isocyanurate triacrylate, and mixtures thereof. In particular, the total weight of aromatic actinically curable monomer in the b) may be from 20 to 100%, from 25 to 95%, from 30 to 90%, from 35 to 85%, from 40 to 80%, from 45 to 75%, from 50 to 70%, based on the total weight of the b). More particularly, the total weight of non-aromatic actinically curable monomer in the b) may be from 0 to 80%, from 5 to 75%, from 10 to 70%, from 15 to 65%, from 20 to 60%, from 25 to 55%, from 30 to 50%, based on the total weight of the b).

According to an embodiment, the b) may be 35 weight % 2-phenoxyethyl acrylate and 10 weight % tris(2-hydroxy ethyl)isocyanurate triacrylate, by weight in the overall composition of the a) and b). For example the b) may preferably be from 10-60 weight %, 15-55 weight %, 20-50 weight %, 25-45 weight %, or 30-40 weight % 2-phenoxyethyl acrylate and from 1-20, 1-19, 3-18, 4-17, 5-16, 6-15, 7-14, 8-13, 9-12, or 9 to 11 weight % tris(2-hydroxy ethyl)isocyanurate triacrylate, by weight in the overall composition of the a) and the b).

Epoxy groups and/or oxetane groups are also contemplated as the actinically curable group on the b) of EX-1. For example, the b) may include at least one epoxy group and/or oxetane group per molecule. Such groups are capable of curing with actinic radiation in the presence of a cation-generating photo-initiator. The b) may comprise, consist of or consist essentially of at least one actinically curable monomer comprising at least one epoxy group and/or at least one oxetane group per molecule. The b) may include at least one epoxy group and/or at least one oxetane group per molecule and at least one (meth)acrylate group per molecule. The b) may comprise, consist of or consist essentially of at least one actinically curable monomer comprising at least one epoxy group and/or at least one oxetane group per molecule and further comprising at least one (meth)acrylate group per molecule. The b) may include a first compound containing at least one epoxy group and/or at least one oxetane group per molecule and a second compound containing at least one (meth)acrylate group per molecule. The b) may comprise, consist of or consist essentially of a first actinically curable monomer comprising at least one epoxy group and/or at least one oxetane group per molecule and a second actinically curable monomer comprising at least one (meth)acrylate group per molecule.

The b) of EX-1 may further include other ethylenically unsaturated functional groups, which are capable of curing with actinic radiation. Non-limiting examples, such as vinylics, styrenics, or malonates, in addition to or as alternatives to (meth)acrylate groups are contemplated according to some embodiments of the disclosure. The b) may further include other ethylenically unsaturated functional groups, such as vinylics, vinyl aromatics, styrenics, malonates, in addition to or as alternatives to (meth)acrylate groups.

Non-limiting particular examples of suitable b) are: trimethylolpropane triacrylate, tricyclodecane dimethanol diacrylate, tris(2-hydroxyethyl) isocyanurate triacrylate, mono- or polyoxyethylene p-cumylphenyl ether acrylate, an ethoxylated bisphenol A diacrylate (in particular ethoxylated3 bisphenol A diacrylate), 2-phenoxyethyl acrylate, 4-tert-butylcyclohexyl acrylate, fluorine acrylates, 9,9 bisphenyl fluorine acrylates, 9,9-bisphenylglycidyl diacrylate, 9,9-bispheno di(meth)acrylate, anthracene (meth)acrylates, cumyl (meth)acrylates, p-cumylphenyl (meth)acrylate, phenyl (meth)acrylates, benzyl (meth)acrylates, phenyl (meth)acrylate, benzyl (meth)acrylate, acrylated bis-phenol (meth)acrylates, coumarin (meth)acrylates, salicylate(meth)acrylates, homosalate(meth)acrylate, phthalic anhydride(meth) acrylates, (meth)acrylate resorcinols, and mixtures thereof.

Representative, but not limiting, examples of suitable monomeric (meth)acrylate-functionalized compounds for the b) of EX-1 include: 1,3-butylene glycol di(meth)acrylate, 1,4-butanediol di(meth)acrylate, 1,6-hexanediol di(meth)acrylate, longer chain aliphatic di(meth)acrylates (such as those generally corresponding to the formula H₂C═CRC(═O)—O—(CH₂)ₘ—O—C(═O)CR′═CH₂, wherein R and R′ are independently H or methyl and m is an integer of 8 to 24), alkoxylated (e.g., ethoxylated, propoxylated) hexanediol di(meth)acrylates, alkoxylated (e.g., ethoxylated, propoxylated) neopentyl glycol di(meth)acrylates, dodecyl di(meth) acrylates, cyclohexane dimethanol di(meth)acrylates, diethylene glycol di(meth)acrylates, dipropylene glycol di(meth)acrylates, alkoxylated (e.g., ethoxylated, propoxylated) bisphenol A di(meth)acrylates, ethylene glycol di(meth)acrylates, neopentyl glycol di(meth)acrylates, tricyclodecane dimethanol diacrylates, triethylene glycol di(meth)acrylates, tetraethylene glycol di(meth)acrylates, tripropylene glycol di(meth)acrylates, ditrimethylolpropane tetra(meth)acrylates, dipentaerythritol penta(meth)acrylates, alkoxylated (e.g., ethoxylated, propoxylated) pentaerythritol tetra(meth)acrylate, dipentaerythritol penta(meth)acrylates, pentaerythritol tetra(meth)acrylate, alkoxylated (e.g., ethoxylated, propoxylated) trimethylolpropane tri(meth)acrylates, alkoxylated (e.g., ethoxylated, propoxylated) glyceryl tri(meth)acrylates, trimethylolpropane tri(meth)acrylates, pentaerythritol tri(meth)acrylates, tris (2-hydroxy ethyl) isocyanurate tri(meth)acrylates, 2(2-ethoxyethoxy) ethyl (meth)acrylates, 2-phenoxyethyl (meth)acrylates, 3,3,5-trimethylcyclohexyl (meth)acrylates, alkoxylated lauryl (meth)acrylates, alkoxylated phenol (meth)acrylates, alkoxylated tetrahydrofurfuryl (meth)acrylates, caprolactone (meth)acrylates, cyclic trimethylolpropane formal (meth)acrylates, dicyclopentadienyl (meth)acrylates, diethylene glycol methyl ether (meth)acrylates, alkoxylated (e.g., ethoxylated, propoxylated) nonyl phenol (meth)acrylates, isobornyl (meth)acrylates, isodecyl (meth)acrylates, isooctyl (meth)acrylates, lauryl (meth)acrylates, methoxy polyethylene glycol (meth)acrylates, octyldecyl (meth)acrylates (also known as stearyl (meth)acrylates), tetrahydrofurfuryl (meth) acrylates, tridecyl (meth)acrylates, triethylene glycol ethyl ether (meth)acrylates, t-butyl cyclohexyl (meth)acrylates, dicyclopentadiene di(meth)acrylates, phenoxyethanol (meth)acrylates, octyl (meth)acrylates, decyl (meth)acrylates, dodecyl (meth)acrylates, tetradecyl (meth)acrylates, cetyl (meth)acrylates, hexadecyl (meth)acrylates, behenyl (meth)acrylates, diethylene glycol ethyl ether (meth)acrylates, diethylene glycol butyl ether (meth)acrylates, triethylene glycol methyl ether (meth)acrylates, dodecanediol di (meth)acrylates, dipentaerythritol penta/hexa(meth)acrylates, pentaerythritol tetra(meth)acrylates, alkoxylated (e.g., ethoxylated, propoxylated) pentaerythritol tetra(meth)acrylates, di-trimethylolpropane tetra(meth)acrylates, alkoxylated (e.g., ethoxylated, propoxylated) glyceryl tri(meth)acrylates, and tris (2-hydroxy ethyl) isocyanurate tri(meth)acrylates, (meth)acrylates of resorcinols, (meth)acrylates of phenol, (meth)acrylates of guauacols, (meth)acrylates of xylenols, (meth)acrylates of creosols, and combinations thereof.

The following compounds are specific examples of mono(meth)acrylate-functionalized monomers suitable for use in the compositions of the present disclosure: methyl (meth)acrylate; ethyl (meth)acrylate; n-propyl (meth)acrylate; n-butyl (meth)acrylate; isobutyl (meth)acrylate; n-hexyl (meth)acrylate; 2-ethylhexyl (meth)acrylate; n-octyl (meth)acrylate; isooctyl (meth)acrylate; n-decyl (meth)acrylate; n-dodecyl (meth)acrylate; tridecyl (meth)acrylate; tetradecyl (meth)acrylate; hexadecyl (meth)acrylate; 2-hydroxyethyl (meth)acrylate; 2- and 3-hydroxypropyl (meth)acrylate; 2-methoxyethyl (meth)acrylate; 2-ethoxyethyl (meth)acrylate; 2- and 3-ethoxypropyl (meth)acrylate; tetrahydrofurfuryl (meth)acrylate; alkoxylated tetrahydrofurfuryl (meth)acrylate; 2-(2-ethoxyethoxy)ethyl (meth)acrylate; cyclohexyl (meth)acrylate; glycidyl (meth)acrylate; isodecyl (meth)acrylate; lauryl (meth)acrylate; alkoxylated phenol (meth)acrylates; alkoxylated nonylphenol (meth)acrylates; cyclic trimethylolpropane formal (meth)acrylate; isobornyl (meth)acrylate; tricyclodecanemethanol (meth)acrylate; tert-butylcyclohexanol (meth)acrylate; trimethylcyclohexanol (meth)acrylate; diethylene glycol monomethyl ether (meth)acrylate; diethylene glycol monoethyl ether (meth)acrylate; diethylene glycol monobutyl ether (meth)acrylate; triethylene glycol monoethyl ether (meth)acrylate; ethoxylated lauryl (meth)acrylate; methoxy polyethylene glycol (meth)acrylates; hydroxyl ethyl-butyl urethane (meth)acrylates; 3-(2-hydroxyalkyl)oxazolidinone (meth)acrylates; and combinations thereof.

Exemplary (meth)acrylate-functionalized monomers containing two or more (meth)acrylate groups per molecule may include ethoxylated bisphenol A di(meth)acrylates; triethylene glycol di(meth)acrylate; ethylene glycol di(meth)acrylate; tetraethylene glycol di(meth)acrylate; polyethylene glycol di(meth)acrylates; 1,4-butanediol diacrylate; 1,4-butanediol dimethacrylate; diethylene glycol diacrylate; diethylene glycol dimethacrylate, 1,6-hexanediol diacrylate; 1,6-hexanediol dimethacrylate; neopentyl glycol diacrylate; neopentyl glycol di(meth)acrylate; polyethylene glycol (600) dimethacrylate (where 600 refers to the approximate number average molecular weight of the polyethylene glycol portion); polyethylene glycol (200) diacrylate; 1,12-dodecanediol dimethacrylate; tetraethylene glycol diacrylate; triethylene glycol diacrylate, 1,3-butylene glycol dimethacrylate, tripropylene glycol diacrylate, polybutadiene diacrylate; methyl pentanediol diacrylate; polyethylene glycol (400) diacrylate; ethoxylated2 bisphenol A dimethacrylate; ethoxylated3 bisphenol A dimethacrylate; ethoxylated3 bisphenol A diacrylate; cyclohexane dimethanol dimethacrylate; cyclohexane dimethanol diacrylate; ethoxylated10 bisphenol A dimethacrylate (where the numeral following “ethoxylated” is the average number of oxyalkylene moieties per molecule); dipropylene glycol diacrylate; ethoxylated4 bisphenol A dimethacrylate; ethoxylated6 bisphenol A dimethacrylate; ethoxylated8 bisphenol A dimethacrylate; alkoxylated hexanediol diacrylates; alkoxylated cyclohexane dimethanol diacrylate; dodecane diacrylate; ethoxylated4 bisphenol A diacrylate; ethoxylated10 bisphenol A diacrylate; polyethylene glycol (400) dimethacrylate; polypropylene glycol (400) dimethacrylate; metallic diacrylates; modified metallic diacrylates; metallic dimethacrylates; polyethylene glycol (1000) dimethacrylate; methacrylated polybutadiene; propoxylated2 neopentyl glycol diacrylate; ethoxylated30 bisphenol A dimethacrylate; ethoxylated30 bisphenol A diacrylate; alkoxylated neopentyl glycol diacrylates; polyethylene glycol dimethacrylates; 1,3-butylene glycol diacrylate; ethoxylated2 bisphenol A dimethacrylate; dipropylene glycol diacrylate; ethoxylated4 bisphenol A diacrylate; polyethylene glycol (600) diacrylate; polyethylene glycol (1000) dimethacrylate; propoxylated neopentyl glycol diacrylates such as propoxylated2 neopentyl glycol diacrylate; diacrylates of alkoxylated aliphatic alcohols; trimethylolpropane trimethacrylate;tris (2-hydroxyethyl) isocyanurate triacrylate; ethoxylated20 trimethylolpropane triacrylate; pentaerythritol triacrylate; ethoxylated3 trimethylolpropane triacrylate; propoxylated3 trimethylolpropane triacrylate; ethoxylated6 trimethylolpropane triacrylate; propoxylated6 trimethylolpropane triacrylate; ethoxylated9 trimethylolpropane triacrylate; alkoxylated trifunctional acrylate esters; trifunctional methacrylate esters; trifunctional acrylate esters; propoxylated3 glyceryl triacrylate; propoxylated5.5 glyceryl triacrylate; ethoxylated15 trimethylolpropane triacrylate; trifunctional phosphoric acid esters; trifunctional acrylic acid esters; pentaerythritol tetraacrylate; di-trimethylolpropane tetraacrylate; ethoxylated4 pentaerythritol tetraacrylate; pentaerythritol polyoxyethylene tetraacrylate; dipentaerythritol pentaacrylate; and pentaacrylate esters.

Suitable epoxy-functionalized actinically curable substances that can be used as the b) of EX-1 include, for example, 3,4-epoxycyclohexylmethyl-3′,4′-epoxycyclohexanecarboxylate, 2-(3,4-epoxycyclohexyl-5,5-spiro-3,4-epoxy)cyclohexane-1,4-dioxane, bis(3,4-epoxycyclohexylmethyl)adipate, vinylcyclohexene oxide, 4-vinylepoxycyclohexane, bis(3,4-epoxy-6-methylcyclohexylmethyl)adipate, 3,4-epoxy-6-methylcyclohexyl-3′,4′-epoxy-6′-methylcyclohexanecarboxylate, methylenebis(3,4-epoxycyclohexane), dicyclopentadiene diepoxide, di(3,4-epoxycyclohexylmethyl) ether of ethylene glycol, ethylenebis(3, 4-epoxycyclohexanecarboxylate), epoxyhexahydrodioctylphthalate, epoxyhexahydro-di-2-ethylhexyl phthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, polyglycidyl ethers of polyether polyol obtained by the addition of one or more alkylene oxides to aliphatic polyhydric alcohols such as ethylene glycol, propylene glycol, and glycerol, diglycidyl esters of aliphatic long-chain dibasic acids, monoglycidyl ethers of aliphatic higher alcohols, monoglycidyl ethers of phenol, cresol, butyl phenol, or polyether alcohols obtained by the addition of alkylene oxide to these compounds, glycidyl esters of higher fatty acids, epoxidized soybean oil, epoxybutylstearic acid, epoxyoctylstearic acid, epoxidized linseed oil, epoxidized polybutadiene, and the like.

Other examples of cationically polymerizable organic substances that can be used in the b) of EX-1 include oxetanes such as 3-ethyl-3-oxetanemethanol, trimethylene oxide, 3,3-dimethyloxetane, 3,3-dichloromethyloxetane, 3-ethyl-3-phenoxymethyloxetane, bis(3-ethyl-3-methyloxy)butane; oxolanes such as tetrahydrofuran 2,3-dimethyltetrahydrofuran, and mixtures thereof.

Other actinically curable monomers may be included in the b) of EX-1. Non-limiting examples are, e.g., α-methylstyrene, 2-methylstyrene, 3-methylstyrene, 4-methylstyrene, 4-propylstyrene, 4-t-butylstyrene, 4-cyclohexylstyrene, 4-dodecylstyrene, 2,4-dimethylstyrene, 2,4-diisopropylstyrene, 2,4,6-trimethylstyrene, 2-ethyl-4-benzylstyrene, 4-(phenylbutyl)styrene, 1-vinylnaphthalene, 2-vinylnaphthalene, vinylanthracene, N,N-diethyl-4-aminoethylstyrene, vinylpyridine, 4-methoxystyrene, monochlorostyrene, dichlorostyrene, divinylbenzene, and combinations thereof.

As discussed above, certain reinforcements may be opaque, transparent or semi-transparent to the energy from cure enhancer(s) 18. Mixtures of more than one reinforcement are within the scope of this disclosure, including embodiments having some opaque reinforcements, some transparent reinforcements and/or some partially-transparent reinforcements.

In one application, the c) of EX-1 may include discontinuous reinforcements (e.g., particles) and may be present in an amount of at least 0.50% by weight of the composition prior to cure and pyrolysis. For example, the composition may include at least 0.6%, 0.7%, 0.8%, 0.9%, 1%, 1.5%, 2%, 3%, 4%, 5%, 6%, 7%, 8%, 9% 10%, 20%, 30%, 40%, 50%, 60%, 70%, 80% or at least 90% by weight of the particles. For example, the composition may include up to 1% by weight of the particles.

In another application, the c) of EX-1 may include discontinuous reinforcements (e.g., fibers) in an amount of at least 0.50% by weight of the curable composition prior to cure and pyrolysis. For example, the actinically curable compositions may include at least 1%, 2%, 3%, 4%, 5%, 6%, 7%, 8%, 9%, 10%, 20%, 30%, 40%, 50%, 60%, 70%, 80% or at least 90% by weight of fibers.

In another application, the c) of EX-1 may include continuous reinforcements (e.g., fibers) in an amount of at least 0.50% by weight of the composition prior to cure and pyrolysis. For example, the composition may include at least 1%, 2%, 3%, 4%, 5%, 6%, 7%, 8%, 9%, 10%, 20%, 30%, 40%, 50%, 60%, 70%, 80% or at least 90% by weight of continuous fibers.

In another application, the c) of EX-1 may include continuous carbon fibers in an amount of at least 0.50% by weight of the curable composition prior to cure and pyrolysis. For example, the composition may include at least 1%, 2%, 3%, 4%, 5%, 6%, 7%, 8%, 9%, 10%, 20%, 30%, 40%, 50%, 60%, 70%, 80% or at least 90% by weight of continuous carbon fibers.

In certain embodiments of the disclosure, the composition described herein may include at least one photoinitiator (i.e., the d) of EX-1) and be curable with radiant energy (visible light and/or ultraviolet light). A photoinitiator may be considered any type of substance that, upon exposure to radiation (e.g., actinic radiation), forms species that initiate the reaction and curing of polymerizing organic substances present in the curable composition. Suitable photoinitiators include only free radical photoinitiators, only cationic photoinitiators, or combinations of both radical photoinitiators and cationic photoinitiators.

Free radical polymerization initiators are substances that form free radicals when irradiated. The photoinitiator may be a phosphine oxide, in particular a mono- or diacylphosphine oxide. Non-limiting examples of diacylphosphine oxides include: phenylbis(2,4,6-trimethylbenzoyl)phosphine oxide). Non-limiting examples of suitable acylphosphine oxides include, but are not limited to, 2,4,6-trimethylbenzoyl-diphenyl-phosphine oxide, bis(2,4,6-trimethylbenzoyl)-phenyl phosphine oxide, bis(2,4,6-trimethylbenzoyl)-(2,4-bis-pentyloxyphenyl)phosphine oxide, and 2,4,6-trimethyl-benzoylethoxyphenylphosphine oxide and combinations thereof.

When the composition contains organic substances with polymerizable (reactive) ethylenically unsaturated functional groups, such as (meth)acrylate functional groups, free radical photoinitiators may be used. Non-limiting types of free radical photoinitiators suitable for use in the composition of the present disclosure include, for example, benzoins, benzoin ethers, acetophenones, benzyl, benzyl ketals, anthraquinones, phosphine oxides, α-hydroxyketones, phenylglyoxylates, α-aminoketones, benzophenones, thioxanthones, xanthones, acridine derivatives, phenazene derivatives, quinoxaline derivatives and triazine compounds. Examples of suitable free radical photoinitiators include, but are not limited to, 2-methylanthraquinone, 2-ethylanthraquinone, 2-chloroanthraquinone, 2-benzyanthraquinone, 2-t-butylanthraquinone, 1,2-benzo-9,10-anthraquinone, benzyl, benzoins, benzoin ethers, benzoin, benzoin methyl ether, benzoin ethyl ether, benzoin isopropyl ether, alpha-methylbenzoin, alpha-phenylbenzoin, Michler's ketone, acetophenones such as 2,2-dialkoxybenzophenones and 1-hydroxyphenyl ketones, benzophenone, 4,4′-bis-(diethylamino) benzophenone, acetophenone, 2,2-diethyloxyacetophenone, diethyloxyacetophenone, 2-isopropylthioxanthone, thioxanthone, diethyl thioxanthone, 1,5-acetonaphthylene, ethyl-p-dimethylaminobenzoate, benzil ketone, α-hydroxy keto, 2,4,6-trimethylbenzoyldiphenyl phosphine oxide, benzyl dimethyl ketal, 2,2-dimethoxy-1,2-diphenylethanone, 1-hydroxycylclohexyl phenyl ketone, 2-methyl-1-[4-(methylthio) phenyl]-2-morpholinopropanone-1, 2-hydroxy-2-methyl-1-phenyl-propanone, oligomeric α-hydroxy ketone, benzoyl phosphine oxides, phenylbis(2,4,6-trimethylbenzoyl)phosphine oxide, ethyl-4-dimethylamino benzoate, ethyl(2,4,6-trimethylbenzoyl)phenyl phosphinate, anisoin, anthraquinone, anthraquinone-2-sulfonic acid, sodium salt monohydrate, (benzene) tricarbonylchromium, benzil, benzoin isobutyl ether, benzophenone/1-hydroxycyclohexyl phenyl ketone, 50/50 blend, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, dibenzosuberenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone, 50/50 blend, 4′-ethoxyacetophenone, 2,4,6-trimethylbenzoyldiphenylphophine oxide, phenyl bis(2,4,6-trimethyl benzoyl)phosphine oxide, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, (cumene)cyclopentadienyl iron(ii) hexafluorophosphate, 9,10-diethoxy and 9,10-dibutoxyanthracene, 2-ethyl-9,10-dimethoxyanthracene, thioxanthen-9-one and combinations thereof.

Suitable cationic photoinitiators include any type of photoinitiator that, upon exposure to radiation such as actinic radiation, forms cations (e.g., Brönsted or Lewis acids) that initiate a reaction of the monomeric and (if present) oligomeric polymerizing organic substances in the disclosed composition. For example, a cationic photoinitiator may be comprised of a cationic portion and an anionic portion. The cationic portion of the photoinitiator molecule can be responsible for the absorption of UV radiation, while the anionic portion may become a strong acid after UV absorption. Suitable cationic photoinitiators include, for example, onium salts with anions of weak nucleophilicity, such as halonium salts, iodonium salts (e.g., diaryliodonium salts such as bis(4-t-butylphenyl) iodonium perfluoro-1-butane sulfonate) or sulfonium salts (e.g., triarylsulfonium salts such as triarylsulfonium hexafluoroantimonate salts); sulfoxonium salts; and diazonium salts. Metallocene salts are another type of suitable cationic photoinitiator.

The amount of photoinitiator in the composition may be varied as may be appropriate, depending upon the particular photoinitiator(s) selected, the amounts and types of polymerizing organic substances (monomeric and oligomeric) present in the composition, the radiation source and the radiation conditions used, among other factors. Typically, however, the amount of photoinitiator may be from 0.05% to 5%, for example 0.1% to 2% by weight, based on the total weight of the curable composition, excluding reinforcement. According to some embodiments, typical concentrations of the photoinitiator may be up to about 15% by weight based on the total weight of the composition, excluding the reinforcement. For example, the composition may comprise from 0.1 to 10% by weight, in total, of the photoinitiator, based on the total weight of the composition, excluding the reinforcement.

In some embodiments, the disclosed composition described herein further includes (e.g., in addition to the photoinitiator) at least one free radical initiator, which decomposes when heated or in the presence of an accelerator and is thus also chemically curable (i.e., in addition to exposing the composition to radiation). The at least one free radical initiator is referred to herein as a thermal initiator. The thermal initiator may, for example, comprise a peroxide or azo compound, in particular an organic peroxide or an azonitrile. Suitable peroxides for this purpose may include any compound, in particular any organic compound, that contains at least one peroxy (—O—O—) moiety, such as, for example, dialkyl, diaryl and aryl/alkyl peroxides, hydroperoxides, percarbonates, peresters, peracids, acyl peroxides and the like. An example of an azonitrile is azobisisobutyronitrile (AIBN). The accelerator may comprise, for example, at least one tertiary amine and/or one or more other reducing agents based on M-containing salts (such as, for example, carboxylate salts of transition M-containing salts such as iron, cobalt, manganese, vanadium and the like and combinations thereof). The accelerator(s) may be selected so as to promote the decomposition of the thermal initiator at room or ambient temperature to generate active free radical species, such that curing of the composition may be achieved without having to heat the composition. In other embodiments, no accelerator is present, and the composition is heated to a temperature effective to cause decomposition of the thermal initiator and thereby generate free radical species that initiate curing of the polymerizable compound(s) present in the composition. Without wishing to be bound by theory, according to some embodiments, an exotherm provided by the photo-induced polymerization may provide enough heat to decompose such chemical (thermal) free radical initiators.

A concentration of thermal initiator in the composition of the present disclosure may be varied as desired, depending upon the particular compound(s) selected, the type or types of polymerizable compound(s) present in the composition, the curing conditions utilized, and the rate of curing desired, among other possible factors. Typically, however, the composition may include from 0.05% to 5%, (e.g., 0.1% to 2%) by weight of the thermal initiator, based on the total weight of the composition, excluding the reinforcement. According to some embodiments, typical concentrations of the thermal initiator may be up to about 15% by weight based on the total weight of the composition, excluding the reinforcement. For example, the composition may comprise from 0.1 to 10% by weight, in total, of the thermal initiator, based on the total weight of the composition, excluding the reinforcement.

These compositions may further include a dual-initiator system, rather than simply relying on UV-initiation alone to produce free radicals and/or cations. Composed of both photoinitiators and thermal initiators, the dual-initiation system may utilize the polymerization exotherm generated from UV-initiation at a surface to initiate the thermal initiators at a side opposite the UV-opaque reinforcements. The heat thus-generated may continue to propagate further into a depth of the composite material discharged from head 16, in a frontal-polymerization process. Non-limiting examples of suitable thermal initiators are azonitriles, such as azobisisobutyronitrile (AIBN). Peroxides are also suitable thermal initiators, for example Luperox© A98 or Luperox LP© available from Arkema. Dicumyl peroxide is another non-limiting example.

### Examples

Tables 1 and 2 provided below illustrate exemplary samples of compositions prepared in a laboratory setting. The samples were prepared by first mixing the a), the b) and the d) of EX-1, as shown in the tables. No reinforcements were used for the samples, since the char is exclusive of the reinforcement. Then, for each sample, a droplet of uncured composition was placed on a glass plate, underneath a UV flood lamp and cured with UV exposure for 30-60 seconds. The samples were then removed from the plate and cut to fit in a TGA sample pan. TGA analysis was used to simultaneously pyrolyze and measure the amount of char provided by the cured composition.

The weight % char of each cured sample (10-30 mg of composition without reinforcement) was measured using a TA Instruments Q50 TGA via the following heating procedure: ramp from room temperature to 300° C. at a ramp rate of 5° C./min, ramp from 300° C. to 400° C. at 1° C./min, hold at 400° C. for 3 hours, ramp from 400° C. to 500° C. at 1° C./min, hold at 500° C. for 3 hours, and finally ramp from 500° C. to 1000° C. A continuous flow of 40-60 mL/min of nitrogen was used as an inert purge gas throughout the heating procedure. The weight % char at a given temperature was determined as the percentage of residual material weight divided by the weight recorded at the start. The weight % char of each sample was reported after being held at 400° C. for 3 hours.

The weight % char provided by the disclosed composition after cure and pyrolysis is reported as (weight ash from TGA)/(weight of the sample after cure and prior to pyrolysis (by TGA)−weight of filler)*100. The weight % char provided by the disclosed composition after cure and pyrolysis will therefore include any other additives in the sample that contribute to char.

TABLE 1

| Component: (wt %) | Example 1 | Example 2 | Example 3 | Example 4 |
|---|---|---|---|---|
| CN2602 mixture of 60% (by weight) | 50 | 100 | 50 | 50 |
| aromatic multifunctional acrylate | | | | |
| component a) having an H/C ratio of | | | | |
| 1.15 and 40% (by weight) aromatic | | | | |
| monoacrylate diluent monomer b) | | | | |
| having an aromatic content of 2 | | | | |
| CD590 aromatic monoacrylate diluent | 50 | | | |
| monomer b) having an aromatic content | | | | |
| of 2 | | | | |
| SR349 diacrylate aromatic diluent | | | 50 | |
| monomer b) having an aromatic content | | | | |
| of 2 | | | | |
| SR339 monoacrylate aromatic diluent | | | | 50 |
| monomer b) having an aromatic content | | | | |
| of 1 | | | | |
| Net H/C Ratio of combination of a) and | 1.14 | 1.15 | 1.13 | 1.12 |
| b), as listed above | | | | |
| Irgacure 819 photo initiator d) | 0.5 | 0.5 | 0.5 | 0.5 |
| Viscosity @25° C., mPa · s before cure | 3,516 | — | 13,568 | 295 |
| Viscosity @60° C., mPa · s before cure | — | 1,657 | — | — |
| TGA char yield, 400° C. hold (wt %) | 20.1 | — | 29.1% | 23.2% |
| TGA char yield, 500° C. hold (wt %) | 15.5 | — | 22.1% | 17.7% |
| TGA char yield, 800° C. hold (wt %) | 13.8 | 20.9% | 19.8% | 16.0% |
| H/C ratio component a) | 1.17 | 1.15 | 1.14 | 1.13 |
| aromatic content (AC) commponent a) | 3.6 | 3.6 | 3.6 | 3.6 |

TABLE 2

| Component: | Example 5 | Example 6 | Example 7 | Example 8 | Example 9 |
|---|---|---|---|---|---|
| SR833 non-aromatic diacrylate diluent | | | | 10.5 | |
| monomer b) | | | | | |
| SR368 non-aromatic triacrylate diluent | | | 10 | 4.5 | 9.2 |
| monomer b) | | | | | |
| CN112C60* mixture of 60% (by | 50 | 60 | 55 | 60 | 53.4 |
| weight) aromatic multifunctional | | | | | |
| acrylate component a) having an H/C | | | | | |
| ratio of 1.15 and 40% (by weight) non- | | | | | |
| aromatic triacrylate diluent monomer b) | | | | | |
| CD590 aromatic monoacrylate diluent | 50 | | | | |
| monomer b) having an aromatic content | | | | | |
| of 2 | | | | | |
| SR339 monoacrylate aromatic diluent | | 40 | 35 | 25 | 33.9 |
| monomer b) having an aromatic content | | | | | |
| of 1 | | | | | |
| SR340 aromatic monoacrylate diluent | | | | | 2.5 |
| monomer b) having an aromatic content | | | | | |
| of 1 | | | | | |
| Net H/C Ratio of combination of a) and | 1.12 | 1.15 | 1.14 | 1.19 | 1.15 |
| b), as listed above | | | | | |
| Irgacure 819 photo initiator d) | 0.5 | 0.5 | 0.5 | 0.5 | 0.5 |
| Luperox P thermal initiator | | | | | 0.5 |
| Viscosity @25° C., mPa · s before cure | 2,450 | 536 | 710 | 1,183 | 620 |
| Viscosity @60° C., mPa · s before cure | — | — | — | — | — |
| TGA char yield, 400° C. hold | 25.1% | 31.0% | 32.0% | 33.6% | 32.5% |
| TGA char yield, 500° C. hold | 19.0% | 23.2% | 22.7% | 23.6% | 24.1% |
| TGA char yield, 800° C. hold | 17.2% | 21.1% | 20.6% | 21.4% | 21.3% |
| H/C ratio component a) | 1.17 | 1.13 | 1.14 | 1.16 | 1.14 |
| aromatic content (AC) component a) | 3.6 | 3.6 | 3.6 | 3.6 | 3.6 |

*The term “acrylated epoxy novolak oligomer” means that the substance is derived from a ring-opened epoxidized composition. This material does not include epoxy groups.

The curable composition disclosed herein is particularly suited to form preform 12a in its final or near-final shape (the green composite) via additive manufacturing, while simultaneously contributing a significant portion of the final carbon content of structure 12 after pyrolysis. Thus, this composition enables a cost-effective and time-saving initial fabrication step, while also reducing a need for further densification and pyrolysis steps. This may contribute to an overall increase in process efficiency.

The disclosed system may be used to fabricate composite structures that can be used in high-temperature applications. The system may fabricate the structures to a net or near-net shape in a localized manner, thereby reducing consumption of expensive resources and time.

### Items

The invention relates to the following items:
Item 1. A method of making a three-dimensional printed carbon-bonded composite article using an additive manufacturing system, comprising:
   discharging from a print head a curable composition, the curable composition including:
      a) at least one aromatic, actinically curable component having an H/C_{atomic ratio} of from 0.4 to 1.6, selected from the group consisting of (meth)acrylate oligomers, epoxy-functionalized compounds, and mixtures thereof,
      b) at least one diluent comprising at least one actinically curable monomer;
      c) a reinforcement; and
      d) a photoinitiator, and
irradiating the curable composition during the discharging to at least partially actinically cure the curable composition and form a preform of the three-dimensional printed carbon-bonded composite article.
Item 2. The method of Item 1, further including pyrolyzing the preform to form the three-dimensional printed carbon-bonded composite article, wherein the curable composition creates more than 18 weight % char after pyrolizing as measured by thermogravimetric analysis after 3 hour hold at 400° C., based on a weight of the a), the b) and the d) after actinically curing.
Item 3. The method of Item 2, wherein the curable composition has a viscosity of at most 60,000 mPa·s at 25° C. prior to irradiating the curable composition.
Item 4. The method of Item 2, wherein the a) has an H/C_{atomic ratio} of from 0.7 to 1.4.
Item 5. The method of Item 2, wherein the b) has an aromatic content of at least 1.
Item 6. The method of Item 2, wherein the curable composition creates at least 20 weight % char after pyrolizing as measured by thermogravimetric analysis after 3 hour hold at 400° C., based on the weight of the a), the b) and the d) after actinically curing.
Item 7. The method of Item 2, wherein the curable composition creates more than 22.5 weight % char after pyrolizing as measured by thermogravimetric analysis after 3 hour hold at 400° C., based on the weight of the a), the b) and the d) after actinically curing. Item 8. The method of Item 2, wherein the curable composition creates more than 25 weight % char after pyrolizing as measured by thermogravimetric analysis after 3 hour hold at 400° C., based on the weight of the a), the b) and the d) after actinically curing.
Item 9. The method of Item 2, wherein the a) comprises a (meth)acrylated novolak.
Item 10. The method of Item 2, wherein a combination of the a) and the b) have a net H/C_{atomic ratio} of from 0.4 to 1.6.
Item 11. The method of Item 2, wherein the a) comprises at least one (meth)acrylate group per molecule.
Item 12. The method of Item 2, wherein the a) comprises at least two (meth)acrylate groups per molecule.
Item 13. The method of Item 2, wherein the a) comprises at least one epoxy group per molecule.
Item 14. The method of Item 2, wherein the a) comprises at least one epoxy group per molecule and at least one (meth)acrylate group per molecule.
Item 15. The method of Item 2, wherein the a) comprises:
   a first compound comprising at least one epoxy group per molecule; and
   a second compound comprising at least one (meth)acrylate group per molecule.
Item 16. The method of Item 2, wherein the b) comprises at least one (meth)acrylate group per molecule.
Item 17. The method of Item 2, wherein the b) comprises at least two (meth)acrylate groups per molecule.
Item 18. The method of Item 2, wherein the b) comprises at least one epoxy group per molecule.
Item 19. The method of Item 2, wherein the b) comprises at least one epoxy group per molecule and at least one (meth)acrylate group per molecule.
Item 20. The method of Item 2, wherein the b) comprises:
   a first compound comprising at least one epoxy group per molecule; and
   a second compound comprising at least one (meth)acrylate group per molecule.
Item 21. The method of Item 2, wherein the c) comprises carbon fibers.
Item 22. The method of Item 2, wherein the c) comprises continuous fibers.
Item 23. The method of Item 2, wherein the c) comprises particles present in an amount of at least 0.5% by weight of the curable composition.
Item 24. The method of Item 2, wherein the c) comprises a fiber and is present in an amount of at least 0.5% by weight of the curable composition.
Item 25. The method of Item 2, wherein:
   the reinforcement is opaque; and
   the curable composition further comprises at least one UV transparent reinforcement.
Item 26. The method of Item 2, wherein the curable composition further includes at least one thermal initiator.
Item 27. The method of Item 1, wherein:
   the a) is an acrylated epoxy novolak resin;
   the b) is selected from the group consisting of ethoxylated3 bisphenol A diacrylate, 2-phenoxyethyl acrylate, tert-butylcyclohexyl acrylate, tricyclodecane dimethanol diacrylate, tris(2-hydroxy ethyl)isocyanurate triacrylate, polyoxyethylene p-cumylphenyl ether acrylate, trimethylolpropane triacrylate, and mixtures thereof;
   the d) is phenylbis(2,4,6-trimethylbenzolyl)phosphine oxide; and
   the curable composition further comprises at least one thermal initiator comprising azobisisobutyronitrile.
Item 28. The method of Item 1, further comprising at least one non-curable char-forming constituent, selected from the group consisting of tar pitches, petroleum products, non-functionalized novolaks, carbore, and mixtures thereof.
Item 29. The method of Item 1, wherein irradiating the curable composition pyrolizes the curable composition in the preform.
Item 30. The method of Item 1, further including densifying the preform with at least one of a liquid and a gas.
Item 31. The method of Item 30, wherein the at least one of the liquid and the gas is the curable composition.
Item 32. The method of Item 30, further including heating the preform to pyrolyze the at least one of the liquid and the gas.
Item 33. The method of Item 32, further including repeating the densifying and the heating until at least a threshold porosity in the three-dimensional printed carbon-bonded composite article is achieved.
Item 34. The method of Item 30, wherein the densifying includes directing the at least one of the liquid and the gas into the preform from a supply located onboard the print head.
Item 35. The method of Item 34, wherein the heating includes directing heat into the preform from a heater located onboard the print head.
Item 36. The method of Item 35, wherein the irradiating includes directing cure energy into the preform from a cure enhancer located onboard the print head.
Item 37. The method of Item 36, wherein the discharging, the irradiating, the densifying, and the heating are completed simultaneously.
Item 38. The method of Item 37, wherein the discharging, the irradiating, the densifying, and the heating are completed at different locations.
Item 39. A method of making a three-dimensional printed carbon bonded composite article, comprising:
   discharging from a print head a curable composition having a viscosity of at most 60,000 cPs at 25° C., the curable composition including:
      a) at least one aromatic, actinically curable component having an H/C_{atomic ratio} of from 0.4 to 1.6, selected from the group consisting of (meth)acrylate oligomers, epoxy-functionalized compounds, and mixtures thereof,
      b) at least one diluent comprising at least one actinically curable monomer;
      c) at least one of a carbon reinforcement and a ceramic reinforcement; and
      d) a photoinitiator,
   directing cure energy from a cure enhancer mounted on the print head to the curable composition during the discharging to at least partially cure the curable composition and form a preform of the three-dimensional printed carbon-bonded composite article;
   heating the preform with a heater mounted on the print head during the discharging to pyrolize the curable composition in the preform, wherein the curable composition creates more than 18 weight % char during the heating as measured by thermogravimetric analysis after 3 hour hold at 400° C., based on a weight of the a), the b) and the d) after actinically curing.
Item 40. The method of Item 30, further including:
   densifying the preform with at least one of a liquid and a gas after the heating; and
   heating the preform to pyrolyze the at least one of the liquid and the gas.

It will be apparent to those skilled in the art that various modifications and variations can be made to the disclosed system and method. Other embodiments will be apparent to those skilled in the art from consideration of the specification and practice of the disclosed system and method. For example, although perhaps less efficient, separate heads may be used to separately fabricate the preform and thereafter locally densify/pyrolyze the preform within a locally shielded environment. It is intended that the specification and examples be considered as exemplary only, with a true scope being indicated by the following claims and their equivalents.

1. A method of making a three-dimensional printed carbon-bonded composite article using an additive manufacturing system, comprising:
discharging from a print head a curable composition, the curable composition including:
a) at least one aromatic, actinically curable component having an H/C_{atomic ratio} of from 0.4 to 1.6, selected from the group consisting of (meth)acrylate oligomers, epoxy-functionalized compounds, oxetane-functionalized compounds and mixtures thereof;
b) at least one diluent comprising at least one actinically curable monomer;
c) a reinforcement; and
d) a photoinitiator, and
irradiating the curable composition during the discharging to at least partially actinically cure the curable composition and form a preform of the three-dimensional printed carbon-bonded composite article.

2. The method of claim 1, further including pyrolyzing the preform to form the three-dimensional printed carbon-bonded composite article.

3. The method of claim 1, wherein the curable composition has a viscosity of at most 60,000 mPa·s at 25° C. prior to irradiating the curable composition.

4. The method of claim 1, wherein the a) comprises an aromatic, actinically curable component having an H/C_{atomic ratio} of from 0.7 to 1.4.

5. The method of claim 1, wherein the b) comprises at least one actinically curable monomer having an aromatic content of at least 1.

6. The method of claim 1, wherein the curable composition creates more than 18 weight % char, after pyrolizing as measured by thermogravimetric analysis after 3 hour hold at 400° C., based on the weight of the a), the b) and the d) after actinically curing.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. The method of claim 1, wherein the c) comprises carbon fibers.

20. The method of claim 1, wherein the c) comprises continuous fibers.

21. The method of any one of claim 1, wherein the c) comprises particles present in an amount of at least 0.5% by weight of the curable composition.

22. (canceled)

23. The method of claim 1, wherein:
the reinforcement is opaque; and
the curable composition further comprises at least one UV transparent reinforcement.

24. The method of claim 1, wherein the curable composition further includes at least one thermal initiator, in particular an azo compound or a peroxide, more particularly an azonitrile or an organic peroxide.

25. The method of claim 1, wherein:
the a) is a (meth)acrylated epoxy novolak resin;
the b) is selected from the group consisting of an ethoxylated bisphenol A diacrylate, 2-phenoxyethyl acrylate, tert-butylcyclohexyl acrylate, tricyclodecane dimethanol diacrylate, tris(2-hydroxy ethyl)isocyanurate triacrylate, mono- or polyoxyethylene p-cumylphenyl ether acrylate, trimethylolpropane triacrylate, and mixtures thereof;
the d) is a phosphine oxide; and
the curable composition further comprises at least one thermal initiator.

26. The method of claim 1, further comprising at least one non-curable char-forming constituent, selected from the group consisting of tar pitches, petroleum products, non-functionalized novolaks, carbore, pitch, lignite, tar, creosote and mixtures thereof.

27. (canceled)

28. The method of claim 1, wherein irradiating the curable composition pyrolizes the curable composition in the preform.

29. The method of claim 1, further including densifying the preform with at least one of a liquid and a gas.

30. The method of claim 29, wherein the at least one of the liquid and the gas is the curable composition.

31. The method of claim 29, further including heating the preform to pyrolyze the at least one of the liquid and the gas.

32. The method of claim 31, further including repeating the densifying and the heating until at least a threshold porosity in the three-dimensional printed carbon-bonded composite article is achieved.

33. (canceled)

34. (canceled)

35. (canceled)

36. (canceled)

37. (canceled)

38. A method of making a three-dimensional printed carbon bonded composite article, comprising:
discharging from a print head a curable composition having a viscosity of at most 60,000 mPa·s at 25° C., the curable composition including:
a) at least one aromatic, actinically curable component having an H/C_{atomic ratio} of from 0.4 to 1.6, selected from the group consisting of (meth)acrylate oligomers, epoxy-functionalized compounds, oxetane-functionalized compounds and mixtures thereof;
b) at least one diluent comprising at least one actinically curable monomer;
c) at least one of a carbon reinforcement and a ceramic reinforcement; and
d) a photoinitiator,
directing cure energy from a cure enhancer mounted on the print head to the curable composition during the discharging to at least partially cure the curable composition and form a preform of the three-dimensional printed carbon-bonded composite article;
heating the preform with a heater mounted on the print head during the discharging to pyrolize the curable composition in the preform, wherein the curable composition creates more than 18 weight % char during the heating as measured by thermogravimetric analysis after 3 hour hold at 400° C., based on a weight of the a), the b) and the d) after actinically curing.

39. The method of claim 38, further including:
densifying the preform with at least one of a liquid and a gas after the heating; and
heating the preform to pyrolyze the at least one of the liquid and the gas.
